(19) United States
(12) Patent Application Publication
(10) Pub. No.: US 2024/0177165 A1
(43) Pub. Date: May 30, 2024

(54) BUFFERING SERVICES FOR SUPPLIERS

(71) Applicant: Onriva LLC, Foster City, CA (US)

(72) Inventors: Vajid H. Jafri, Redwood Shores, CA (US); Hassan J. Abbas, Brisbane, CA (US); Michael Joseph d’Almada-Remedios, Discovery Bay, CA (US)

(21) Appl. No.: 18/497,986

(22) Filed: Oct. 30, 2023

Related U.S. Application Data
(63) Continuation-in-part of application No. 17/517,405, filed on Nov. 2, 2021.

(51) Int. Cl. G06Q 20/40; G06F 3/04842; G06F 16/9538; H04L 67/306; H04L 67/50

(52) U.S. Cl. CPC G06Q 20/4016; G06F 3/04842; G06F 16/9538; H04L 67/306; H04L 67/535

(57) ABSTRACT

Methods for reducing fraudulent activities associated with credit card and debit card usage can include a better authentication process, such as getting to know the customers, thus can detect the fraudulent activities when the credit payments do not fit the usage patterns of the customers. The method can include presenting the flight search result in a matrix format and a listing format, with the actions of the customers assessed to generate behavior profiles. The behavior profile can be used authenticate the customers. In addition, the method can include replacing a payment from a customer to a supplier with a different payment from a platform to the supplier.

### CROSS REFERENCE TO RELATED APPLICATIONS

This application is a continuation-in-part of U.S. application Ser. No. 17/517,405, filed Nov. 2, 2021, which is incorporated by reference in its entirety.

### BACKGROUND

Services through the Internet are constantly increasing. The Internet enables one to purchase services and products using on-line services. Payments for on-lines services are typically through credit cards and debit cards. Originally, a customer would present a credit card to a merchant, and the merchant simply accepts the credit card payment.

Then fraud became widespread. As the use of credit cards on the Internet increases, so too does the increase of credit card fraud, e.g., misused by a malevolent eavesdropper or untrustworthy payee.

To prevent fraud and other financial losses, credit card companies impose spending limits and issuing printed lists of lost/stolen cards, but the process is proved ineffective in preventing fraud. As an added measure, the merchants are required to contact a transaction authorization center to get pre-approval for transactions.

To improve the authorization process, such as to create additional barriers for fraudsters, additional security measures, such as magnetic stripes or embedded chips, were added to the credit cards. These additional barriers can allow near real-time control of fraudulent card usage. But detecting and reacting appropriately to fraud remained a problem.

FIG. 1 illustrates prior art payment scheme according to some embodiments. A customer 110 can contact a supplier 120, for example, to inquire about a product of service offered by the supplier. The contact can be performed through the Internet. After deciding on a product or service, the customer can send a payment, such as a credit card payment 140, to the supplier. The supplier then sends the credit card information to a credit card processing service, for example, to get approval for the credit card payment.

The supplier is partially responsible for the credit card payment, e.g., when the transaction is a fraudulent transaction, the supplier incurs a loss associated with the fraudulent credit card.

Therefore, a need exists for an improved system to reduce credit card losses for the suppliers.

### SUMMARY

In some embodiments, the present invention discloses methods and systems for reducing fraudulent activities associated with credit card and debit card usage. The methods can potentially reduce payment card fraud, for example, through a better authentication process, such as getting to know the customers, thus can detect the fraudulent activities when the credit payments do not fit the usage patterns of the customers. For example, the systems can maintain a database for storing customer information related to the customer habits in credit purchases, with the database used for verifying the authenticity of the credit charges incurred by the customers. The database can be periodically updated, for example, with credit information from credit agencies, such as credit report or score from the credit bureau, and with credit information of the customers collected and processed by the system, including address, password, date-of-birth or other password-verifying information. Further, the credit information can be processed by a machine learning algorithm, such as an artificial intelligence, to identify spending patterns of the customers, which can help in identifying fraudulent activities, e.g., activities not fitted in the customer spending habit.

In some embodiments, the present invention discloses a method, and a platform to perform the method, for forming a buffering service between customers and suppliers. The buffering service can be configured to replace a payment from a customer to a supplier with a different payment.

In some embodiments, the present invention discloses a method for a buffering service between customers and suppliers. The method can include receiving a payment from a customer. The customer payment can be payment for a service or product offered by a supplier and purchased by the customer.

The method can further include assessing a characteristic of the customer payment using a database. The characteristic can include an identity characteristic, such as the identity of the owner of the credit card, for example, to prevent the credit payment from a stolen credit card.

The method can further include issuing a different payment to the supplier for the service or product. The payment, such as a credit card payment, can be made from the buffering service to the supplier. Thus, the payment can be secured.

In some embodiments, the present invention discloses a service platform that can aggregates and intelligently orchestrates several payment platforms to enable and optimize global and local payment types and terms for consumers, while shielding suppliers from the diverse operational complexities of accepting and managing risk, fraud and chargebacks through those many payment methods.

This enables consumers to buy products however they want, and provides suppliers a quick and easy way to maximize their sales while simplifying their payment related operational complexity, cost and fraud losses.

In some embodiments, the present invention discloses a method to form a profile for a user, which can be used to authenticate the user through an AI algorithm comparing a current action or a current communication session to a behavior pattern of the user generated based on the profile. For example, forming and updating a user behavior profile by the actions of the customers and by the communication of the customer with the platform can provide a pattern of the customer behavior. The platform can use the AI algorithm to determine if the current action or communication of the customer is inconsistent or deviated from the past behavior pattern. The deviation thus can signal a potentially fraudulent activity.

The behavior of the customers can be determined from actions of the customers on a display showing multiple products or services based on a search input from the customers. The display can include a matrix configuration showing the products or services on a multidimensional matrix, with the dimensions showing features and values or ranges of the features. The display can include a listing configuration showing the products or services in a list showing details of the products or services.

In some embodiments, the present invention discloses a method for modifying one or more fields of a transaction. The transaction is originated from a sending entity or party to a receiving entity party to provide the receiving entity or party with a value of the transaction. The transaction is routed to an intermediate party, e.g., the intermediate party is configured to receive the transaction, then to forward or send the transaction to the receiving party. The transaction is modified to have a pass by value characteristic, instead of a pass by reference characteristic.

### BRIEF DESCRIPTION OF THE DRAWINGS

FIG. 1 illustrates prior art payment scheme according to some embodiments.

FIGS. 2A-2B illustrate a database for storing customer information according to some embodiments.

FIG. 3 illustrates a platform for maintaining a customer credit database according to some embodiments.

FIGS. 4A-4D illustrate flow charts for forming a customer credit database according to some embodiments.

FIGS. 5A-5B illustrate flow charts for updating a customer credit database according to some embodiments.

FIGS. 6A-6B illustrate configurations of a buffering service according to some embodiments.

FIGS. 7A-7D illustrate flow charts for forming a buffering service according to some embodiments.

FIG. 8 illustrates a flow chart for performing a buffering service according to some embodiments.

FIGS. 9A-9B illustrate schematics of processing a payment from a customer according to some embodiments.

FIGS. 10A-10B illustrate flow charts for processing a payment from a customer according to some embodiments.

FIGS. 11A-11B illustrate schematics for processing a payment to a supplier according to some embodiments.

FIGS. 12A-12B illustrate flow charts for processing a payment to a supplier according to some embodiments.

FIGS. 13A-13B illustrate schematics for payment configurations to a supplier according to some embodiments.

FIGS. 14A-14C illustrate flow charts for payment configurations to a supplier according to some embodiments.

FIG. 15 illustrates a schematic for a buffering configuration according to some embodiments.

FIGS. 16A-16C illustrate flow charts for shielding configurations to a supplier according to some embodiments.

FIG. 17 illustrates a schematic of a buffering service platform according to some embodiments.

FIG. 18 illustrates a flow chart for forming a buffering service platform according to some embodiments.

FIG. 19 illustrates a flow chart for forming a travel reservation platform according to some embodiments.

FIGS. 20A-20D illustrate operation schematics for a buffering service platform according to some embodiments.

FIG. 21 illustrates a flow chart for operating a buffering service platform according to some embodiments.

FIG. 22 illustrates a flow chart for operating a travel reservation platform according to some embodiments.

FIGS. 23A-23B illustrate computing environments according to some embodiments.

FIGS. 24A-24C illustrate display configurations for the search results of a hotel according to some embodiments.

FIGS. 25A-25B illustrate display configurations for the search results of a travel plan according to some embodiments.

FIGS. 26A-26B illustrate positive and negative selection processes for a flight matrix according to some embodiments.

FIGS. 27A-27B illustrate OR and AND selection processes for a flight matrix according to some embodiments.

FIGS. 28A-28B illustrate expanded and contracted flight matrices according to some embodiments.

FIGS. 29A-29B illustrate a re-arrangement of flight matrices according to some embodiments.

FIGS. 30A-30C illustrate a re-arrangement of flight matrices according to some embodiments.

FIGS. 31A-31B illustrate flight matrices to be displayed on a screen according to some embodiments.

FIG. 32 illustrates a configuration of a behavior profile according to some embodiments.

FIG. 33 illustrates a flow chart for authenticating a user according to some embodiments.

FIG. 34 illustrates a flow chart for processing a user transaction according to some embodiments.

FIG. 35 illustrates a flow chart for processing a user transaction according to some embodiments.

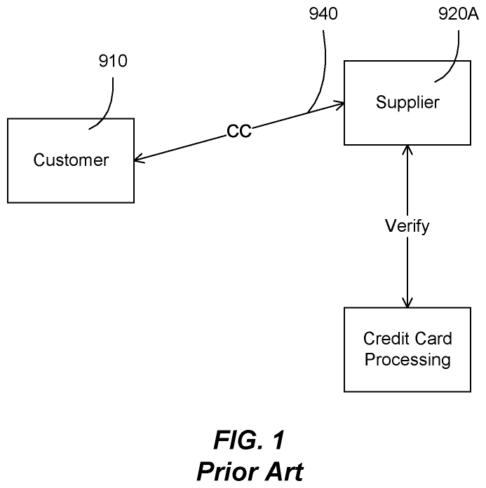

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In some embodiments, the present invention discloses methods and systems for reducing fraudulent activities associated with credit card and debit card usage, such as for authentication and verification of credit card payments via telecommunications and for detecting credit card fraud attempts from credit purchases. The methods can potentially reduce payment card fraud, such as through automated payment card fraud detection. For example, the methods can provide better authentication when a customer performs credit payments to a supplier.

In some embodiments, the methods can include getting to know the customers, thus can detect the fraudulent activities when the credit payments do not fit the usage patterns of the customers. For example, the systems can maintain a database for storing customer information related to the customer habits in credit purchases, with the database used for verifying the authenticity of the credit charges incurred by the customers. The database can be periodically updated, for example, with credit information from credit agencies, such as credit report or score from the credit bureau, and with credit information of the customers collected and processed by the system, including address, password, date-of-birth or other password-verifying information. Further, the credit information can be processed by a machine learning algorithm, such as an artificial intelligence, to identify spending patterns of the customers, which can help in identifying fraudulent activities, e.g., activities not fitted in the customer spending habit.

In some embodiments, the present fraud detection method can verify that the customer providing a credit payment is the actual owner of the credit card. A credit card can have embedded elements that can uniquely identify the account cardholder. For example, a credit card number can have a system number, a bank or product number, a user account number, and a check digit. The credit card number is typically sixteen digits. The first six digits are the bin number of the credit card, and represent the card network, the bank and the product for this bank. The last digit is reserved for the checksum of the previous digits of the credit card number. The credit card can also include an expiration date, and the cardholder's name or business.

To reduce fraud, several security features have been added to payment cards. For example, a pin code is primarily used for debit card-present transactions, and is remembered by the cardholder. Another feature is a Card Verification Value (CVV), Card Verification Code (CVC), or a second CVC (CVV2) on the credit card.

A major type of transactions is “Card-Present”, in which the credit card is presented for the transactions, such as for point-of-sale (POS) or Automatic Teller Machines (ATM). Card-Present transactions involve magnetic card or embedded chip readers, and can make use of the full digits of the credit card number, together with the 4-digit expiration date.

For e-commerce, increased transactions are becoming “Card-Not-Present,” in which the credit card is not presented for the transactions, such as for Internet and on-line transactions. Generally, Card-Not-Present transactions require the user to enter the credit card number, the expiration data, and sometimes the CVC/CVV2 number.

Card-Not-Present transactions are likely to be subject fraud. To limit these fraudulent activities, various fraud detection and prevention methods have been developed, such as the use of Virtual Account numbers, authentication of cardholders separate from transaction, and use of hardware token to authenticate the user.

For example, a Virtual Account Number, which is a substitute single-use credit card number, can allow customers to shop online without having to transmit their actual card details over the Internet. A limitation with using Virtual Account Numbers is to get new number for each transaction. Another authentication process is a direct request from the bank to the customer to verify the transaction. This request will let the bank knows that the right person is making the purchase.

For example, a potentially fraudulent activity is the occurrence of transactions which occur concurrently or which are placed from different geographic regions within a sufficiently short time interval.

Another potentially fraudulent activity detection can include comparing the identification of the customer telecommunication, such as the country, the IP address or the computer identification with a predetermined list of suspected fraud users.

Another potentially fraudulent activity detection can include a list of locations and date when the fraudulent activities occur, for example, by having sufficient data to determine when, e.g., by the transaction date, and where, e.g., by the merchant ID.

In some embodiments, the present fraud detection can include additional security authentications will need additional forms of identification, in addition to their credit or debit card details. The additional identification can include customer's knowledge, such as password, PIN number, secret questions, or a numerical sequence; customer possession, such as mobile phone, wearable devices, token, or smartcard; or customer inherent feature, such as fingerprint, voice recognition, iris recognition, or facial features.

In some embodiments, the additional security authentications can include Two Factor Authentication, such as One Time Passwords and biometric authentication. The biometric method, such as using fingerprints or facial recognition, can greatly reduce the amount of fraud while not presenting additional inconvenience for the customers.

The additional security authentications can include using a larger number of data to be verified in the credit card transactions. For example, the data can be obtained from the bank. The data can be supplied by the customers, such as the email address or billing address. The data can come from the customer's device and browser data.

In some embodiments, the credit transaction can be authenticated through a risk-based authentication, which is the process of determining the risk attached to a particular transaction. And then based on the risk level, additional authentication steps should be required from the customers. The risk-based elements can include the value of the transaction, a new or existing customer, a transactional history, a behavioral history, and the device information of the customer.

For example, if a new card is used with no transactional history, the risk can be high, and additional authentication steps will be required. If there is a purchase history but the transaction is performed on a new device, additional authentication steps can be needed since there is an unknown variable. In contrast, if the card is already in the system with the customer using the card to make payments, the risk can be low. The system can authenticate the credit transaction without the need for additional authentication steps.

In general, the additional security authentications can be applied to the customers until the credit card issuing banks have sufficient data and confidence to for the risk-assessment of the credit card transactions.

In some embodiments, the present invention discloses a machine learning process, such as using an artificial intelligence (AI) algorithm, to assist in processing the incoming data to be stored in the database. The machine learning process can also be configured to process data from the database for the authentication and verification of the credit payments of the customers. For example, the database can store information and activities from the customer. The AI algorithm can assemble patterns of spending of the customers, and can assist in detecting potential deviation from the spending patterns, which can serve as indications of fraud.

AI algorithm can quickly complete the fraud detection analysis to obtain and detect complex pattern deviations, much faster and complete than human fraud analysts. The AI algorithm can perform the time-consuming and routine tasks, with the human fraud analysts focusing on critical cases.

AI algorithm can be programmed to detect anomaly behaviors of the customers, for example, by comparing the current credit payments of the customers with the customer profiles or patterns, such as processing all the customer data collected by the database with AI pattern recognition algorithms and machine learning. The customer patterns can include average and standard deviation values, including moving averages.

For example, an anomaly event is an event that rarely happens. When the AI anomaly detection identifies that the current credit payment does not generally occur for the customer, e.g., the credit payment is outside of the normal purchase behavior of the customer, the system can determine that the credit risk can be high, and thus can require additional authentication steps.

The customer profiles used in AI anomaly detection can include historical usage patterns of customer credit cards and other predictive triggers. A potential fraud is suggested for any indication of a deviation in the historical usage patterns. For example, if a customer incurs a large oversea purchase after a long period of local credit purchases, it can indicate a potential fraudulent transaction. Additional security measures to determine the customer identity can be required. Other anomaly activities can include a quick series of electronic equipment purchases after normally using the credit card for small everyday purchases, such as gas and groceries.

Other anomaly activities can include deviations from communication behavior, such as communication duration (the average length in time of a communication), communication velocity (the number of communication in a specified time period), and communication thresholds (the highest number of communication in a specified time period).

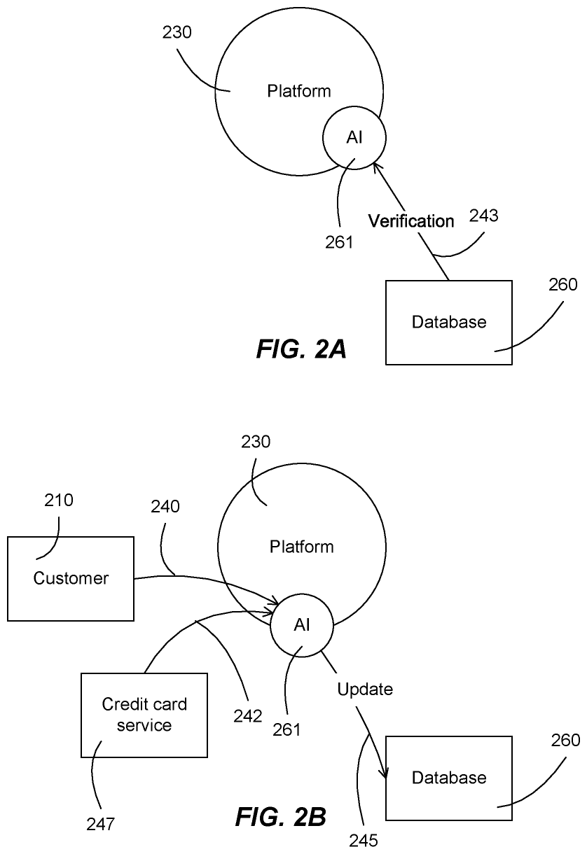

FIGS. 2A-2B illustrate a database for storing customer information according to some embodiments. In FIG. 2A, a system, such as a platform 230, can have an AI module 261, e.g., a program having a machine learning or AI algorithm, for processing data from a database 260. In operation, after the platform receives a credit payment from a customer, AI processed data 243 from the database can be used to verify the authentication of the credit purchase, such as to the identity of the customer.

In FIG. 2B, the platform 230 can receive 242 data from credit agencies 247, such as from a credit report agency, from data in the public domain, or from a banking institution, for information regarding the customers, such as credit history and other personal information. The data can be directly stored in the database 260, or can be processed by the AI module 261, such as for pattern analysis, before storing or updating 245 the raw data and the processed data in the database 260. The processed data can speed up the credit authentication process, e.g., allowing the customer usage patterns to be determined before an analysis of a new credit payment.

The platform 230 can also receive 240 data from the customers 210, such as from customer profiles supplied by the customers, or from data inferred from the customer location (through IP address, for example) and from customer equipment (through the equipment ID of the customer computer or cell phone). The data can be directly stored in the database 260, or can be processed by the AI module 261 before being stored in the database 260.

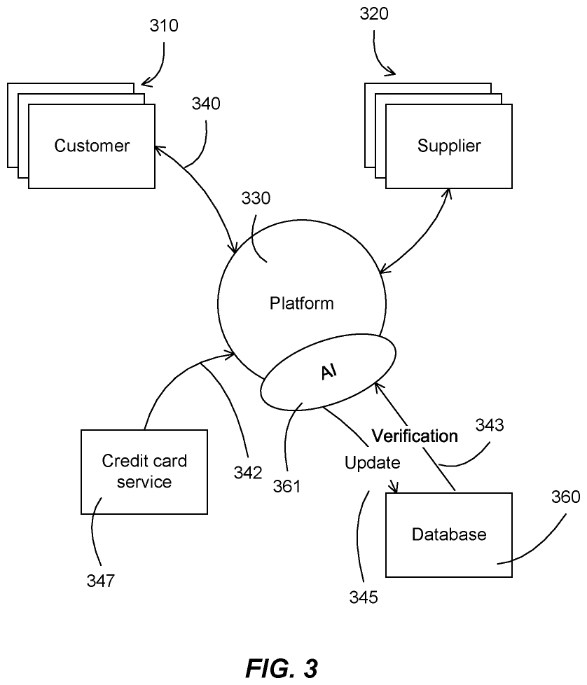

FIG. 3 illustrates a platform for maintaining a customer credit database according to some embodiments. A platform 330 can be configured to provide products and services from one or more suppliers 320 to customers 310. For example, the platform can have access to the inventories of the suppliers, such as a list of products and services with their description. Upon receiving an inquiry from a customer, the platform can search the inventories and then display the search results for the customer. The customer can select one or more products or services, and can proceed for payment, such as by a credit card. The platform can process the credit payment, using a database 360, e.g., using data from the database to verify 343 the authentication of the credit purchase, such as to the identity of the customer, or the credit limit imposed by the credit card issuer.

In some embodiments, the platform 330 can have an AI module 361, which can be equipped with AI or machine learning, to assist in the analysis of the credit purchase. Data in the database can be added 345 from credit agencies 347, such as from credit card services. Data in the database can be added 340 from the customers 310, such as from customer profiles supplied by the customers, or from data inferred from the customer communication with the platform such as the customer location and communication equipment. The usage of a database together with AI or machine learning can allow an improvement in fraud detection.

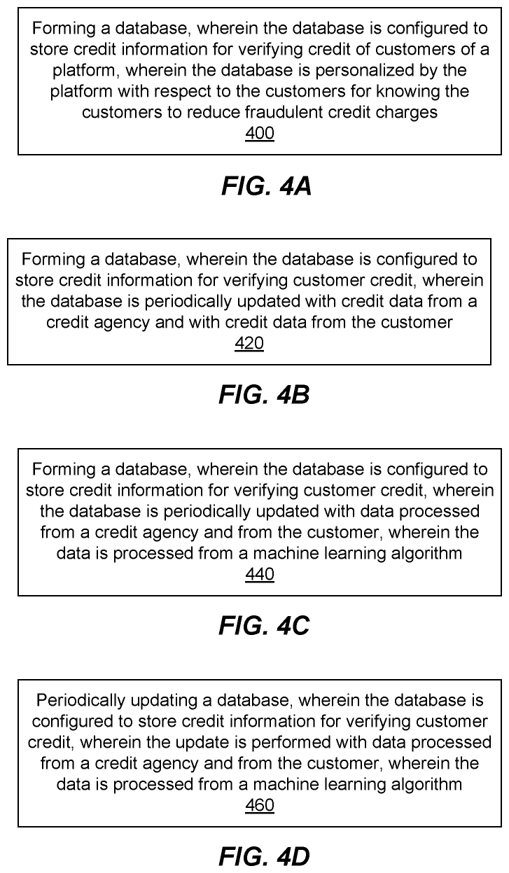

FIGS. 4A-4D illustrate flow charts for forming a customer credit database according to some embodiments. In FIG. 4A, operation 400 forms a database, with the database configured to store credit information for verifying credit of customers of a platform. Data in the database can be personalized by the platform with respect to the customers for knowing the customers to reduce fraudulent credit charges.

In FIG. 4B, operation 420 forms a database, with the database configured to store credit information for verifying customer credit. Data in the database can be periodically updated with credit data from a credit agency and with credit data from the customer.

In FIG. 4C, operation 440 forms a database, with the database configured to store credit information for verifying customer credit. Data in the database can be periodically updated with data processed from a credit agency and from the customer, with the processed data generated by a machine learning or AI algorithm.

In FIG. 4D, operation 460 periodically updates a database, with the database configured to store credit information for verifying customer credit. The database update is performed with data processed from a credit agency and from the customer, with the processed data generated by a machine learning or AI algorithm.

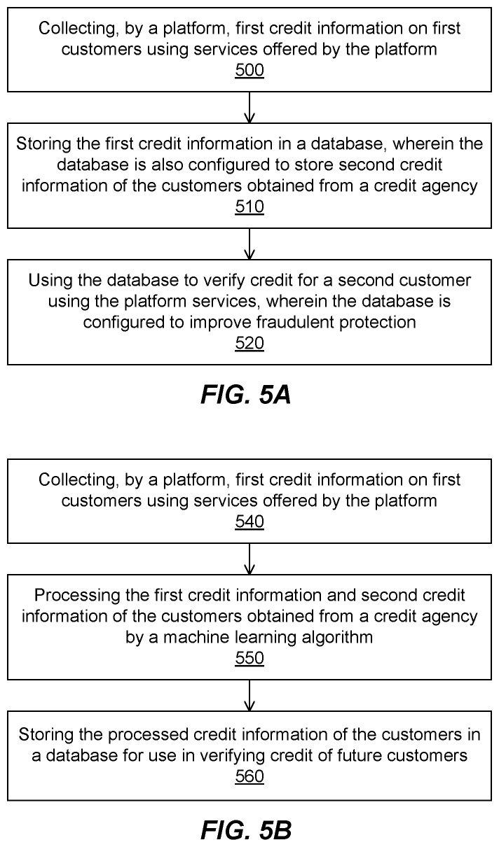

FIGS. 5A-5B illustrate flow charts for updating a customer credit database according to some embodiments. In FIG. 5A, operation 500 collects, by a platform, first credit information on first customers using services offered by the platform. Operation 510 stores the first credit information in a database, wherein the database is also configured to store second credit information of the customers obtained from a credit agency. Operation 520 uses the database to verify credit for a second customer using the platform services, wherein the database is configured to improve fraudulent protection.

In FIG. 5B, operation 540 collects, by a platform, first credit information on first customers using services offered by the platform. Operation 550 processes the first credit information and second credit information of the customers obtained from a credit agency by a machine learning algorithm. Operation 560 stores the processed credit information of the customers in a database for use in verifying credit of future customers.

In some embodiments, the present invention discloses a method, and a platform to perform the method, for forming a buffering service between customers and suppliers. The buffering service can shield the suppliers from fraudulent charges, for example, from determining if a payment from the customers is legitimate or to handle any post sale transactions and disputes. The buffering service can be configured to shield the supplier from financial risks relating to the customer, e.g., from the customer payment. The buffering service can also function as a one-stop shop for the customers, e.g., the customers can discuss post sale transactions with the buffering service, instead of dealing with multiple suppliers with different procedures and paperwork.

In some embodiments, the buffering service can be configured to replace a payment from a customer to a supplier with a different payment. For example, the customer payment can be a credit payment from the customer, sending to the buffering service to pay for a product or service from the supplier. The customer payment can be a high risk payment, such as due to a fraudulent transaction, e.g., from a customer with bad credit, or from an unauthorized person performing the credit payment. The payment from the buffering service can be a secured payment, based on the reputation of the buffering service, especially for suppliers having prior engagements with the buffering service. By accepting payments from the customers, the buffering service is in a position to accept the financial risks, for example, due to fraudulent payments, and to shift the financial risks from the suppliers to the buffering service. The buffering service is thus configured to handle customer problems related to fraudulent payments, and can also represent the suppliers to discuss problems with the customers.

In some embodiments, the buffering service can be run on a platform, such as on a server communicating with customers and suppliers through a network, such as the Internet. The platform can be configured to provide products and services from multiple suppliers to customers looking for products or services through the platform. For example, the platform can have access to the inventories of the suppliers, including products and services offered by the suppliers together with their description and other information such as product reviews or rating.

In operation, a customer can send an inquiry to the platform, indicating the items the customer would like to see. The platform can search the inventories from the suppliers and then display the search results to the customer. The customer can select one or more products or services, and can proceed for payment, such as by sending a credit card, a debit card, or other types of payment to the platform. The platform can process the payment, such as checking for fraudulent activities, and then proceed to send a different payment to the supplier.

In some embodiments, the present invention discloses a method for a buffering service between customers and suppliers. The method can include receiving a payment from a customer. The payment can be a credit card payment, a debit card payment, a cash payment, a wire transfer payment, a bank transfer payment, a check payment, a cashier check payment, or a payment through a payment agency such as Paypal. The customer payment can be payment for a service or product offered by a supplier and purchased by the customer.

In some embodiments, the customer payment is an on-line payment, e.g., without the presence of the customer or the means of payment, such as the credit card or the debit card. Thus, the customer payment is subjected to a fraudulent risk, for example, due to a stolen credit card, a customer having bad credit or exceeding the credit limit of the credit card.

The method can further include assessing a characteristic of the customer payment using a database. The characteristics can include a financial characteristic, such as a risk rate, a credit score, a trustworthiness of the payment. The financial characteristic can include an interest rate of the credit card, or an interchange fee imposed on the credit transactions by the bank issuing the credit card. The characteristic can include an identity characteristic, such as the identity of the owner of the credit card, for example, to prevent the credit payment from a stolen credit card.

In some embodiments, the buffering service can include an AI-processed database for a better authentication and verification of the credit payment, thus can significantly reduce the fraudulent risk for the buffering service. Thus, the database can be configured to provide an estimate of the characteristic, e.g., an assessment of the fraudulent risk associated with the credit card payment. Further, the database is configured to be periodically updated to provide a better estimate of the characteristic of the credit card transaction.

In some embodiments, the buffering service can have an AI module, which can be equipped with AI or machine learning, to assist in the analysis of the credit purchase. Data in the database can be added from credit agencies, such as from credit card services. Data in the database can be added from the customers, such as from customer profiles supplied by the customers, or from data inferred from the customer communication with the platform such as the customer location and communication equipment. The usage of a database together with AI or machine learning can allow an improvement in fraud detection.

The method can further include issuing a different payment to the supplier for the service or product. The payment, such as a credit card payment, can be made from the buffering service to the supplier. Thus, the payment can be secured, at least in the buffering service point of view. For suppliers having prior engagements with the buffering service, the payment is also secured, since it comes from a trusted service, e.g., a service that the suppliers are comfortable with listing their products for sale.

In some embodiments, the payment from the buffering service to the platform is a credit card payment, such as a payment from a one-time-use credit card. For example, the buffering service can have an agreement or a contract with a credit issuing institution, such as a bank, to issue multiple one-time-use credit cards. The one-time-use credit card is a credit card configured to be used only one time, such as a virtual credit card or a temporary credit card.

A virtual credit card is a randomly generated 16-digit number associated with an actual credit card account. The virtual credit card can be issued by the issuing bank of the credit card account, for example, to protect against fraud for shopping without presenting the physical credit card. The virtual credit card sometimes can be called a temporary card number or a pseudo card number. The virtual credit card can have a credit or debit card number, which can be used for secured online purchases. The virtual card can have a maximum charge limit to prevent overcharged. The virtual card can be locked to a specific supplier to prevent the card from being used elsewhere.

In some embodiments, the one-time-use credit card can be linked to a credit card of the buffering service. However, the one-time-use credit does not have to be linked to a credit card. For example, the one-time-use credit card can be issued by the bank based on an agreement with the buffering service, and can be secured by the credit or collateral from the buffering service.

In some embodiments, the one-time-use credit card carries the name of the customer. The customer name on the credit card can let the supplier know that the credit card payment is from the customer. Additionally, the one-time-use credit card carrying the customer name can shield the buffering service from the obvious payment trail, e.g., from the supplier point of view, the payment is made by the customer, and not a different payment from the buffering service.

The one-time-use credit card can also be selected to be a similar credit card type as the credit card used by the customer to pay for the product or service. For example, if the customer uses a Visa card to pay, the one-time-use credit card can also be a Visa card. The one-time-use credit card can be selected to have a few of the credit card numbers to be similar to the credit card used by the customer.

In some embodiments, the present specification relates to credit card payments, e.g., payments by a credit card or by a debit card. A credit or debit card can have a cardholder, e.g., the owner of the credit or debit card, such as a person or a corporation. The name of the cardholder can be present on the credit or debit card. The cardholder can open an account with bank issuing the credit or debit card, and can obtain a credit or debit card from the issuing bank. The cardholder can use the account to pay for goods or services using the credit or debit card, to a supplier or a merchant.

The supplier or the merchant is a company offering products or services, and can accept card payments in exchange for the goods or services. The merchant can establish a merchant account with a merchant bank, which can allow the merchant to accept deposits from credit and debit card payments.

When the customer pays the merchant with a credit or debit card, the payment can go through a payment processor, which is a company that processes credit and debit card transactions. The payment processors connect the merchant, the merchant bank, the customer, and the customer issuing card bank to perform the credit or debit card payments.

The issuing banks can issue credit and debit cards to cardholders through the card associations, which include Visa, MasterCard, Discover and American Express. The card associations set interchange rates and serve to settle disputes between the issuing banks and the merchant banks.

In operation, the customer first provides a payment through his credit or debit card to a merchant to pay for the products or services. The merchant then sends a request for payment authorization to a payment processor. The payment processor submits transactions to the appropriate card association, and eventually reaching the issuing bank. The issuing bank approves or declines the transaction. The issuing bank then sends the approval or denial decision back to the card association, merchant bank and to the merchant.

After a certain period of time, such as at the end of a business day, the merchant send the authorized transactions, e.g., credit or debit card payment receiving the approval decision from the issuing bank, to the payment processor. The payment processor then sends details of the transactions to the card associations, which then communicates with the issuing bank. The issuing bank charges the account of the cardholder for the amount of the transactions, and then transfers appropriate transaction payments to the merchant bank, minus interchange fees, which are transaction fees that the merchant bank account must pay to the card issuing bank to cover handling costs, fraud, bad debt costs and the risk involved in approving the payment. Upon receiving the payments, the merchant bank deposits the payments into the merchant account.

In some embodiments, the method can control or limit the risk of non-payment to the supplier by the buffering service accepting the risk and by the buffering service sending secured payments to the supplier. The method can protect the suppliers from fraudulent chargebacks by the buffering service accepting the credit or debit payments. The method can also protect the buffering service from fraudulent chargebacks by an AI authentication process through an AI module with a large and constantly updated database.

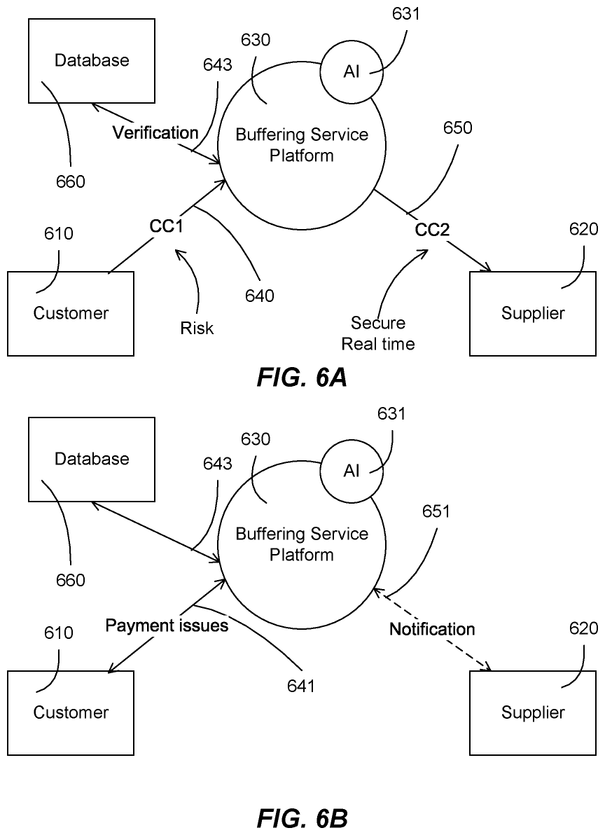

FIGS. 6A-6B illustrate configurations of a buffering service according to some embodiments. The buffering service can be configured to receive payments from customers, and then send another payment to suppliers. The buffering service can include a constantly update database to know customer credit information, agreements with banks to generate credit or debit used for payment. The buffering service can function as a one stop shop for customer in dealing with multiple suppliers, and can handle all post sale transactions for the suppliers.

In FIG. 6A, a buffering service platform 630 can be configured to provide products and services from one or more suppliers 620 to customers 610. For example, upon receiving an inquiry from a customer, the platform can search inventories of the suppliers and then display the search results for the customer. The customer can select one or more products or services, and can proceed 640 for payment, such as by a credit card CC1. The platform can process the credit payment, using a database 660, e.g., using data from the database to verify 643 the authentication of the credit purchase, such as to the identity of the customer, or the credit limit imposed by the credit card issuer. In some embodiments, the platform 630 can have an AI module 661, which can be equipped with AI or machine learning, to assist in the analysis of the credit purchase.

The platform then can send 650 another different payment CC2 to the supplier. The payment from the platform can be more secured than the payment from the customer, since the platform is known to the supplier, for example, through an agreement to display products or services on the platform.

In FIG. 6B, the platform can be configured to handle all post sale transactions from the customer. The customer can communicate 641 with the platform regarding issues related to the payment from the customer, such as a fraudulent transaction from a stolen credit card. The platform can settle the fraud charges with the customer, without involving the supplier. For issues related to the products or services obtained by the customer, such as a broken product or a poor-performance service, the platform can function as an intermediate or an arbiter between the customer and the supplier. For example, the platform can discuss 641 the issues with the customer, and also discuss 651 the issues with the supplier using the argument with the customer. Thus, the customer and the supplier can be seen as dealing only with the platform.

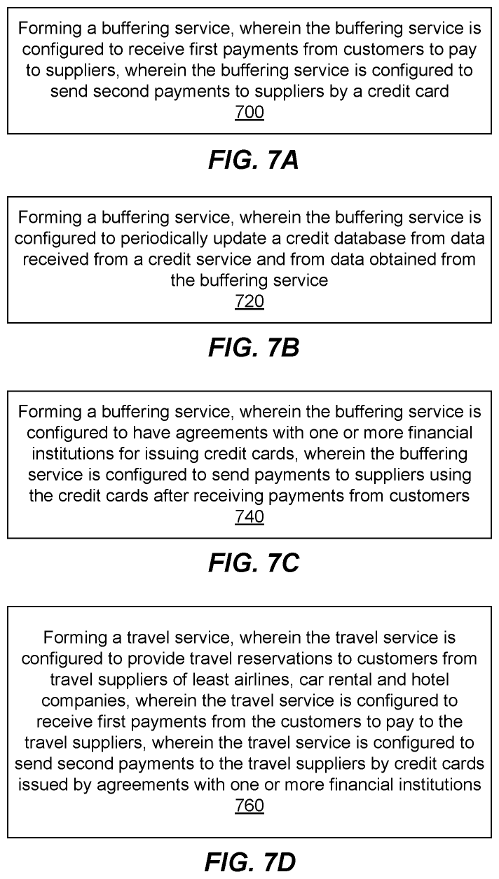

FIGS. 7A-7D illustrate flow charts for forming a buffering service according to some embodiments. In FIG. 7A, operation 700 forms a buffering service. The buffering service is configured to receive first payments from customers to pay to suppliers. The buffering service is configured to send second payments to suppliers by a credit card.

In FIG. 7B, operation 720 forms a buffering service, with the buffering service configured to periodically update a credit database from data received from a credit service and from data obtained from the buffering service.

In FIG. 7C, operation 740 forms a buffering service. The buffering service is configured to have agreements with one or more financial institutions for issuing credit cards. The buffering service is configured to send payments to suppliers using the credit cards after receiving payments from customers.

In FIG. 7D, operation 760 forms a travel service. The travel service is configured to provide travel reservations to customers from travel suppliers of least airlines, car rental and hotel companies. The travel service is configured to receive first payments from the customers to pay to the travel suppliers. The travel service is configured to send second payments to the travel suppliers by credit cards issued by agreements with one or more financial institutions.

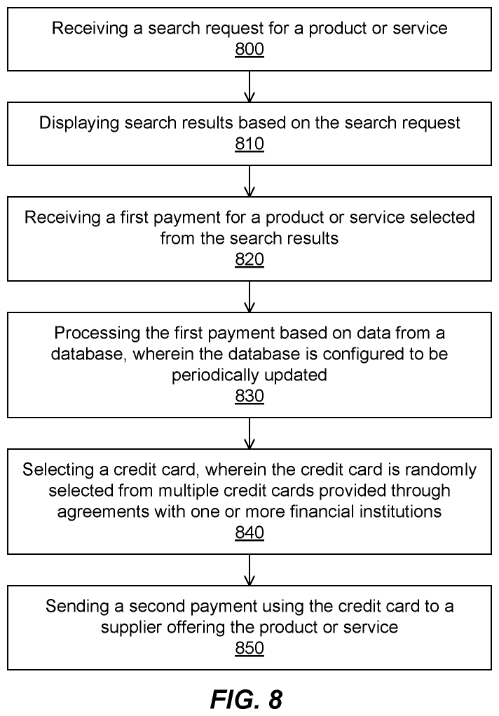

FIG. 8 illustrates a flow chart for performing a buffering service according to some embodiments. Operation 800 receives a search request for a product or service. Operation 810 displays search results based on the search request. Operation 820 receives a first payment for a product or service selected from the search results. Operation 830 processes the first payment based on data from a database, wherein the database is configured to be periodically updated. Operation 840 selects a credit card, wherein the credit card is randomly selected from multiple credit cards provided through agreements with one or more financial institutions. Operation 850 sends a second payment using the credit card to a supplier offering the product or service.

In some embodiments, the buffering service can be configured to process and receive a payment from a customer. By providing an AI processed database, the buffering service can perform prescreen on the identity of the customer, such as through additional security verification. The prescreening process can eliminate or significantly reduce the risk of fraudulent payment transactions.

For example, the customer verification can first include verifying a location of the customer together with a verification of the equipment that the customer uses to perform the payment. The customer verification can include an anomaly detection, performed by an AI module based on the AI processed database, to see if the current payment behavior fits into the customer payment patterns or if the current payment behavior provides an indication of a deviation from the customer payment patterns. The additional security verification can continue until the AI module is satisfied that the fraudulent risk is low, e.g., there is a very high chance that the customer is indeed the owner of the credit card presented for payment.

In addition, the buffering service can further reduce the fraudulent transactions for the suppliers by accepting the fraudulent risk through accepting the payments from the customers, and then issue other payments to the suppliers, using the buffering service credit.

In some embodiments, the buffering service can include a database for processing payments from customers. The database can be updated using a machine learning methodology or AI. The database can be used to process the credit payments from the customers, such as to verify that the customer is the owner of the credit card used in the payment. The database can be used to verify financial information related to the customer and to the credit card used by the customer, such as to determine an interchange fee for the credit card used by the customers.

In some embodiments, some financial aspects of the customer credit can be verified by a credit check, for example, the credit limits of the credit card or the credit worthiness of the customer.

In some embodiments, an AI algorithm can be used for processing the data from the database, for example, to generate spending patterns of the customer. The AI module can also be used to calculate a probability that the current payment is within or outside the normal ranges of the customer spending habit or patterns.

The database can be constantly updated, for example, to include up-to-date data by adding new data. The database can periodically or constantly update with data from credit agencies, from the customers, and from public or private institutions. For example, the interchange fees for the credit cards, which can be related to fraud rates, can be monthly updated to reflect the current interchange fees imposed on the credit card.

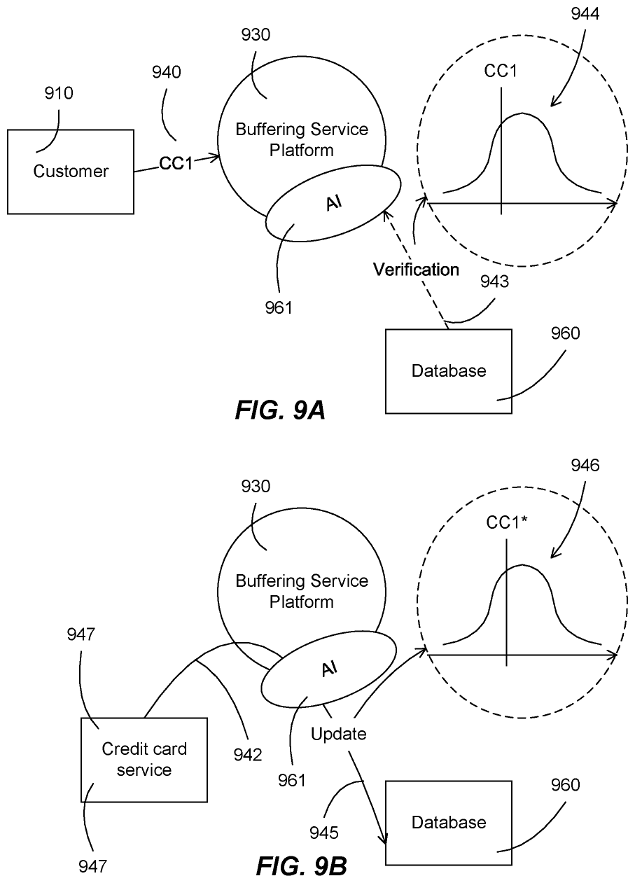

FIGS. 9A-9B illustrate schematics of processing a payment from a customer according to some embodiments. In FIG. 9A, a buffering service platform 930 can be configured to receive a payment 940, such as a credit card payment, from customer 910. The platform can process the credit payment, using a database 960, e.g., using data from the database to verify 943 the authentication of the credit purchase, such as to the identity of the customer, the credit limit imposed by the credit card issuer, or the interchange fee imposed by the credit card. In some embodiments, the platform 930 can have an AI module 961, which can be equipped with AI or machine learning, to assist in the analysis of the credit purchase.

As an example, a credit profile or pattern 944 of the credit payment of the customer can be shown, with the data CC1 showing the specific credit characteristic of the customer, such as the interchange fee for the credit card used by the customer.

In FIG. 9B, the platform 930 can receive 942 data from credit agencies 947, such as from a credit report agency, from data in the public domain, or from a banking institution, for information regarding the customers, such as credit history and other personal information. The data can be directly stored in the database 960, or can be processed by the AI module 961, such as for pattern analysis, before storing or updating 945 the raw data and the processed data in the database 960. The processed data can speed up the credit authentication process, e.g., allowing the customer usage patterns to be determined before an analysis of a new credit payment.

The platform 930 can also receive 940 data from the customers 910, such as from customer profiles supplied by the customers, or from data inferred from the customer location (through IP address, for example) and from customer equipment (through the equipment ID of the customer computer or cell phone). The data can be directly stored in the database 960, or can be processed by the AI module 961 before being stored in the database 960.

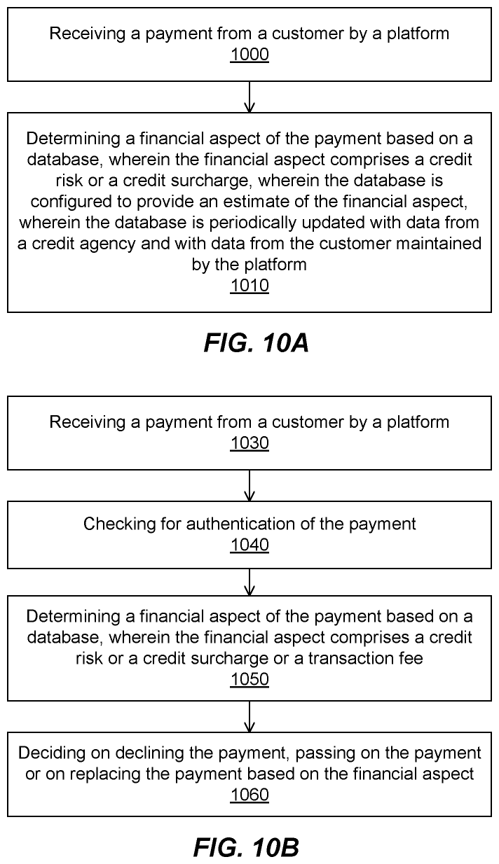

FIGS. 10A-10B illustrate flow charts for processing a payment from a customer according to some embodiments. In FIG. 10A, operation 1000 receives a payment from a customer by a platform. Operation 1010 determines a financial aspect of the payment based on a database. The financial aspect can include a credit risk or a credit surcharge. The database can be configured to provide an estimate of the financial aspect. The database can be periodically updated with data from a credit agency and with data from the customer maintained by the platform.

In FIG. 10B, operation 1030 receives a payment from a customer by a platform.

Operation 1040 checks for authentication of the payment. Operation 1050 determines a financial aspect of the payment based on a database, with the financial aspect comprises a credit risk or a credit surcharge or an interchange fee. Operation 1060 decides on declining the payment, passing on the payment or on replacing the payment based on the financial aspect.

In some embodiments, the buffering service can send a payment to the supplier, after the buffering service receives a different payment from the customer. The buffering service can have an improved authentication process, such as based on an AI-processed database, and thus can significantly reduce the risk of fraudulent identity, e.g., accepting a stolen credit card. The risk reduction can be further transferred to the supplier, by the buffering accepting responsibility for the customer payment, e.g., the buffering service becomes the recipient of the customer payment, and not the supplier.

The buffering service then can send a different payment to the supplier, under the name of the customer and for a same amount. The payment from the buffering service to the supplier can be a credit card payment, such as a one-time-use credit card payment, since the same card is not likely to be used again. The one-time-use credit card can be a virtual card, in the sense that the one-time-use card can simply be a string of number, e.g., the number for the one-time-use credit card, and not a physical card. The one-time-use credit card is different from conventional virtual credit cards, since the conventional virtual credit cards are issued under the name of the owner of the actual or physical credit cards corresponding to the virtual credit cards.

In contrast, the present one-time-use credit cards are issued under the customer name, with the owner is actually the buffering service. Thus, the buffering service can have an agreement or a contract with a credit card issuing institution, such as with a bank, to supply the buffering service with multiple one-time-use credit cards having name and amount filled in by the buffering service.

In some embodiments, the one-time-use credit card can have as much similarity to the credit card used by the customer, for example, by having the same credit card association such as the same Visa or the same MasterCard, or by having the same last 4 digits of the credit card.

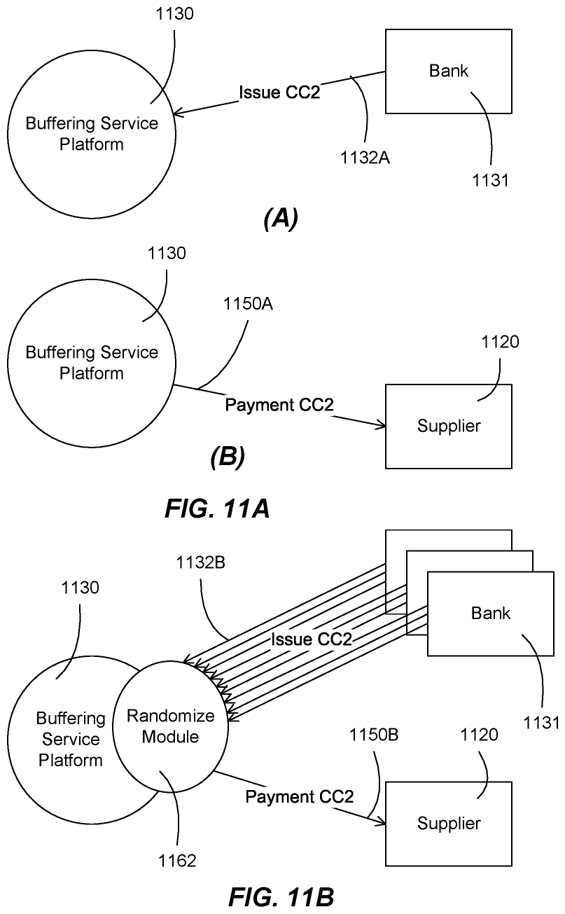

FIGS. 11A-11B illustrate schematics for processing a payment to a supplier according to some embodiments. FIGS. 11A(A) and 11A(B) show a process in which the buffering service sends a credit card payment to a supplier, after being issued the credit card by a credit card issuing institution, such as a bank.

In FIG. 11A(A), the buffering service platform 1130 can have an agreement with a bank 1131 that has the ability to issue credit cards. The agreement can provide that the bank will issue 1132A multiple one-time-use credit cards to the buffering service platform, with the card association (e.g., a Visa card, a MasterCard, etc.), the name on the card, and card amount to be supplied by the platform. The bank can issue a list of credit card numbers for the platform to choose. The card issuance can be based on a credit or a collateral of the platform. For example, the bank can agree to a daily or monthly credit limit based on the credit of the platform, e.g., after checking the credit worthiness of the platform.

In FIG. 11A(B), the buffering service platform 1130, after receiving a payment from a customer to pay for a product or service offered by a supplier 1120, can send 1150A a credit card payment to the supplier. The credit card can be a one-time-used credit card, with the name on the card being the name of the customer, and the amount on the card being the amount of the customer payment.

In some embodiments, the buffering service platform can have a randomizing module configured to select a credit card number among the credit card number supplied by a bank. Alternatively, the buffering service platform can have agreements with multiple banks, with each bank supplying a number of credit card numbers. The randomizing module can be configured to select a credit card number in a random fashion among the available credit card numbers.

The randomization can serve to avoid certain automatic fraud detection in some credit card processing services, which can automatically flag the payment as fraud when observing a repetition, multiple credit cards having a same characteristic in a short time period.

In FIG. 111B, the buffering service platform 1130 can have agreements with one or more credit card issuing banks 1131, which can issue 1132B multiple one-time-use credit cards to the buffering service platform, with the card association (e.g., a Visa card, a MasterCard, etc.), the name on the card, and card amount to be supplied by the platform.

The buffering service platform 1130, after receiving a payment from a customer to pay for a product or service offered by a supplier 1120, can use a randomizing module 1162 to randomly select a credit card among the available credit cards issued by the banks 1131. The platform then can send 1150B a payment to the supplier, using the randomly selected credit card number.

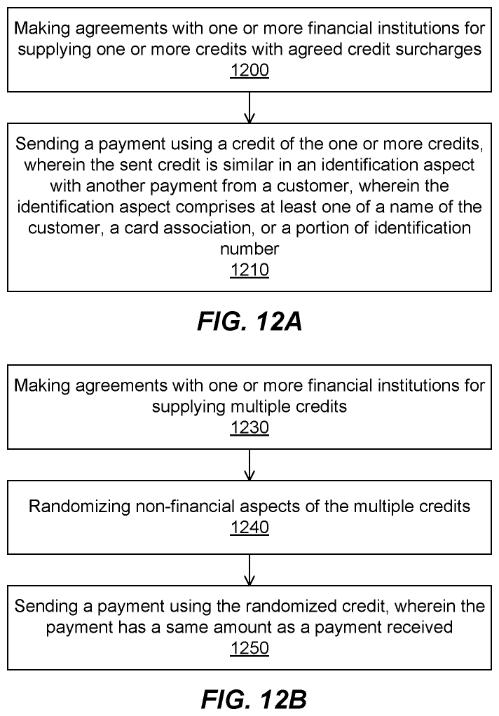

FIGS. 12A-12B illustrate flow charts for processing a payment to a supplier according to some embodiments. In FIG. 12A, operation 1200 makes agreements with one or more financial institutions for supplying one or more credit cards with agreed credit interchange fees. Operation 1210 sends a payment using a credit card of the one or more credit cards, with the sent credit card being similar in an identification aspect with another payment from a customer, and with the identification aspect including at least one of a name of the customer, a card association, or a portion of identification number.

In FIG. 12B, operation 1230 makes agreements with one or more financial institutions for supplying multiple credit cards. Operation 1240 randomizes aspects of the multiple credit cards to select a credit card. Operation 1250 sends a payment using the randomized credit card, with the payment having a same amount as a payment received, and a same name as a customer name.

In some embodiments, the payment to the supplier can be through a credit card or a debit card. The credit or debit card can be supplied by the platform, or can be provided by the supplier.

Since the payment from the buffering service is secured, the buffering service can guarantee the payment, for example, through a secured credit card, a preload debit card, or other forms of secure payments.

In some embodiments, the payment by the buffering service platform to the supplier can be a regular credit card payment, a secured credit card payment, a balance credit card payment, or a preload debit card payment. In a regular credit card payment, the supplier can get payment from credit card issued bank transferred to its bank.

In a secured credit card payment, the secured credit card is pre-loaded with cash, e.g., the secured credit card is based on cash collateral and not based on credit. Thus, the secured credit card is secured with the platform depositing money in the issuing bank. The secured credit card is different from a regular credit card is that in the regular credit card, the credit card issuing bank issues the credit card to the platform based on the credit worthiness of the platform.

In a balance credit card payment, the platform can transfer payment as balance to a credit card, with the credit card number supplied by the platform or by the supplier. For the credit card supplied by the platform, the platform can send to the supplier a preload balance credit card, e.g., a physically credit card or a virtual credit card (e.g., a credit card number), with the credit card having a balance amount equal to the amount of the payment.

For the credit card number supplied by the supplier, the supplier can provide the platform with a credit card number that can accept balance transfer. The platform then can send a payment, which can appear as a balance amount on the supplier supplied credit card. The supplier than can use the credit card for other payments, with the spending money subtracted from the balance of the credit card.

This mode of payment requires that the credit card provided by the platform or by the supplier accepts money transferred to the credit card in the form of a balance, e.g., the amount of money that the supplier overpaid the credit card. This mode of payment can be useful for some suppliers do not have regular access to bank, such as a foreign supplier, or for suppliers who prefer to carry money on a credit card.

In a preload debit card payment, the platform can transfer payment as preloaded money to a debit card, with the debit card number supplied by the platform or by the supplier. For the debit card supplied by the platform, the platform can send to the supplier a preload debit card, e.g., a physically debit card or a virtual debit card (e.g., a debit card number), with the debit card preloaded with the amount of the payment. For the debit card supplied by the supplier, the supplier can provide the platform with a debit card number. The platform then can load the received debit card with a payment, which can appear as a preloaded amount on the supplier supplied debit card.

After obtaining the preload debit card, which is either supplied by the platform or by the supplier, the supplier than can use the debit card for other payments, with the spending money subtracted from the balance of the preloaded debit card. This mode of payment can be useful for some suppliers do not have regular access to bank, such as a foreign supplier, or for suppliers who prefer to carry money on a debit card.

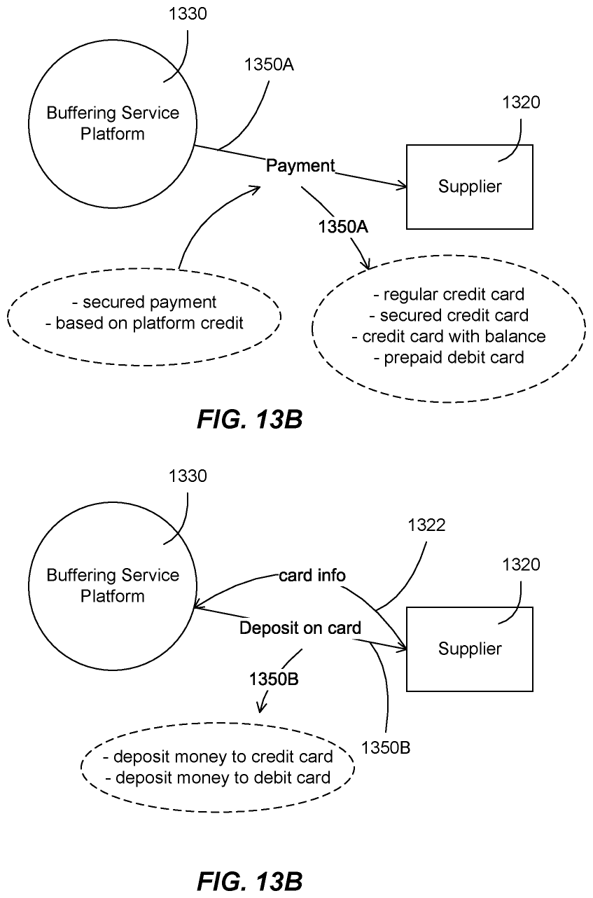

FIGS. 13A-13B illustrate schematics for payment configurations to a supplier according to some embodiments. In FIG. 13A, a buffering service platform 1330 can send 1350A a payment to a supplier 1320. The payment can be a secure payment, e.g., backed by the platform credit. The payment can be a regular credit card, e.g., the platform sending the supplier with a credit card number with an agreement to pay the customer amount from the credit card number. The payment can be a secured credit card, e.g., the platform sending the supplier with a credit card number with the credit card secured by cash instead of credit. The payment can be a balance credit card such as a credit card having a balance on the credit card, e.g., the platform sending the supplier with a credit card number with the credit card having a balance amount equal to the payment amount sent by the customer. The payment can be a preload debit card, e.g., the platform sending the supplier with a debit card number with the debit card being preloaded with an amount equal to the payment amount sent by the customer.

In FIG. 13B, the buffering service platform 1330 can receive 1322 information for a credit or debit card from the supplier 1320. The platform 1330 can send 1350B a payment to the supplier 1320, using the information supplied by the supplier. The payment can be a credit card with a balance, e.g., the platform putting money into the supplier provided credit card number in the form of a balance amount to the credit card, with the balance amount equal to the payment amount sent by the customer; or a preload debit card, e.g., the platform putting money into the supplier provided credit card number in the form of a preloaded amount to the debit card, with the preloaded amount equal to the payment amount sent by the customer.

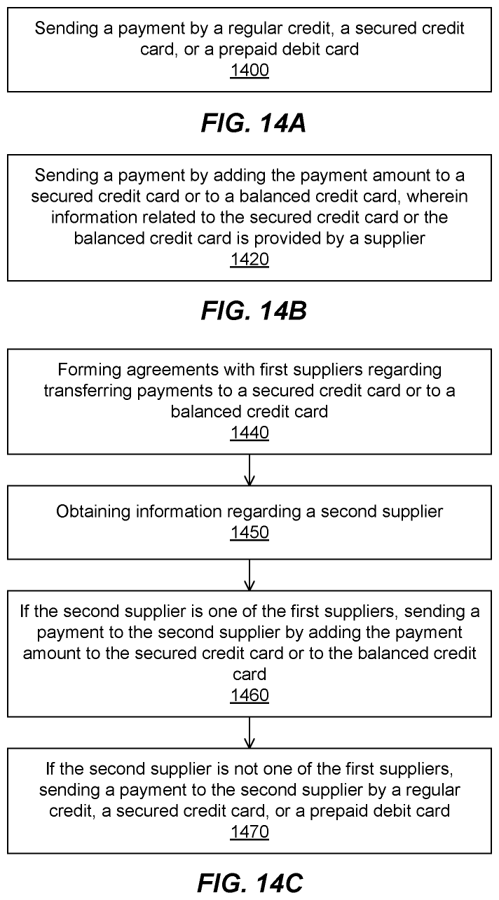

FIGS. 14A-14C illustrate flow charts for payment configurations to a supplier according to some embodiments. In FIG. 14A, operation 1400 sends a payment by a regular credit, a secured credit card, or a prepaid debit card.

In FIG. 14B, operation 1420 sends a payment by adding the payment amount to a secured credit card or to a balanced credit card, with information related to the secured credit card or the balanced credit card provided by a supplier.

In FIG. 14C, operation 1440 forms agreements with first suppliers regarding transferring payments to a secured credit card or to a balanced credit card. Operation 1450 obtains information regarding a second supplier. Operation 1460 sends a payment to the second supplier by adding the payment amount to the secured credit card or to the balanced credit card, if the second supplier is one of the first suppliers. Operation 1470 sends a payment to the second supplier by a regular credit, a secured credit card, or a prepaid debit card, if the second supplier is not one of the first suppliers.

In some embodiments, the buffering service platform can function as a one stop shop for the customers. The buffering service can be disposed between the suppliers and the customers, thus can function as a one-stop shop for the customers, e.g., instead of having multiple contacts, with each contact representing a supplier, the customers have a single contact of the buffering service. Every presale, sale, and post-sale transaction can go to the buffering service.

For example, a customer can contact the buffering service to search for products and services offered by multiple suppliers. The buffering service is also configured to handle customer problems, e.g., the buffering service can represent the suppliers to discuss with the customers regarding issues such as payment, product, or service disputes

In some embodiments, the buffering service can be configured to isolate or shielding the suppliers from the customer disputes or financial actions, such as in events like complaints or chargebacks. For example, if a customer paid for an item but not received it, or received it damaged, the customer can dispute the charge with the buffering service to get the money back, instead of disputing with the supplier.

Chargebacks and refunds all allow the customers to get their money back for fraudulent charges or purchases that do not meet common standards. However, chargebacks are different from refunds, in which a refund comes directly from a supplier, while a chargeback comes from the card issuer.

A first step is to go to the supplier to ask for a refund. If the supplier refuses to credit the purchase, a chargeback can be requested from the card issuer. Situations that qualify for requesting a chargeback include fraud or unauthorized charges, products or services that not delivered, damaged or defective items, and incorrect charges.

In some embodiments, the buffering service can be configured to shift fraudulent risk such as refunds or chargebacks from the suppliers to the buffering service, for example, by accepting the payments from the customers. The fraudulent risk can be acceptable to the buffering service due to the improve fraud detection based on the AI processed database.

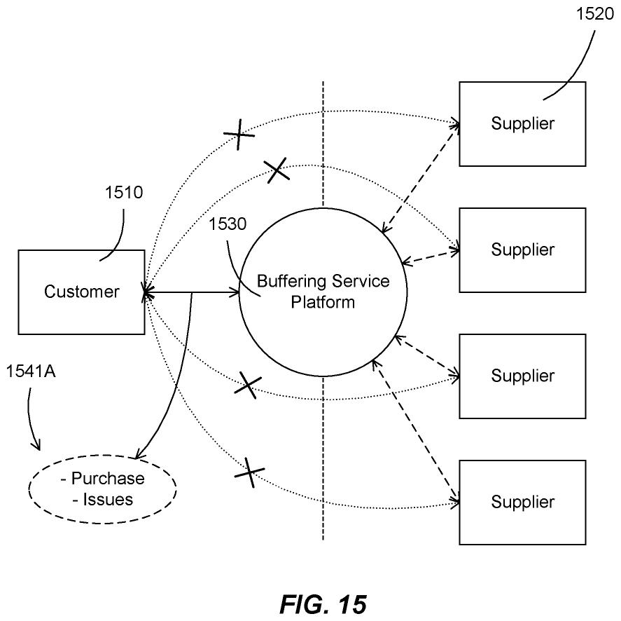

FIG. 15 illustrates a schematic for a buffering configuration according to some embodiments. A buffering service 1530 can serve as a platform between the customers 1510 and the suppliers 1520. The buffering service can function as a one-stop shop for the customers, e.g., the customers can discuss issues 1541A related to the purchases with the platform, instead of to multiple individual suppliers.

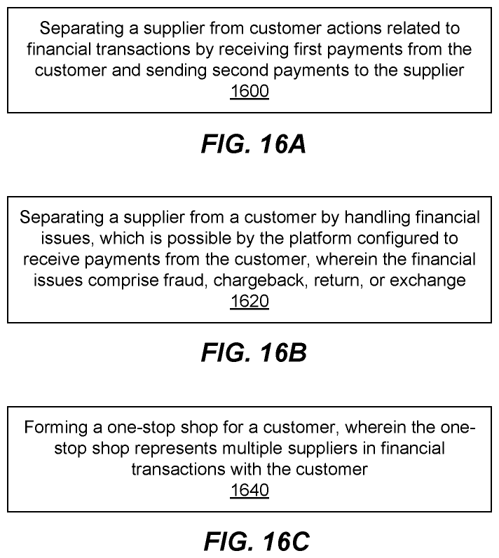

FIGS. 16A-16C illustrate flow charts for shielding configurations to a supplier according to some embodiments. In FIG. 16A, operation 1600 separates a supplier from customer actions related to financial transactions by receiving first payments from the customer and sending second payments to the supplier. In FIG. 16B, operation 1620 separates a supplier from a customer by handling financial issues, which is possible by the platform configured to receive payments from the customer, with the financial issues including fraud, chargeback, return, or exchange. In FIG. 16C, operation 1640 forms a one-stop shop for a customer, wherein the one-stop shop represents multiple suppliers in financial transactions with the customer.

In some embodiments, the present invention discloses a buffering service platform functioning as a one-stop-shop for customers in dealing with multiple suppliers. The platform can also assist the suppliers in taking the risk of credit payments from the customers. The suppliers can receive payments from the platform, which is secured and can be guaranteed by the platform.

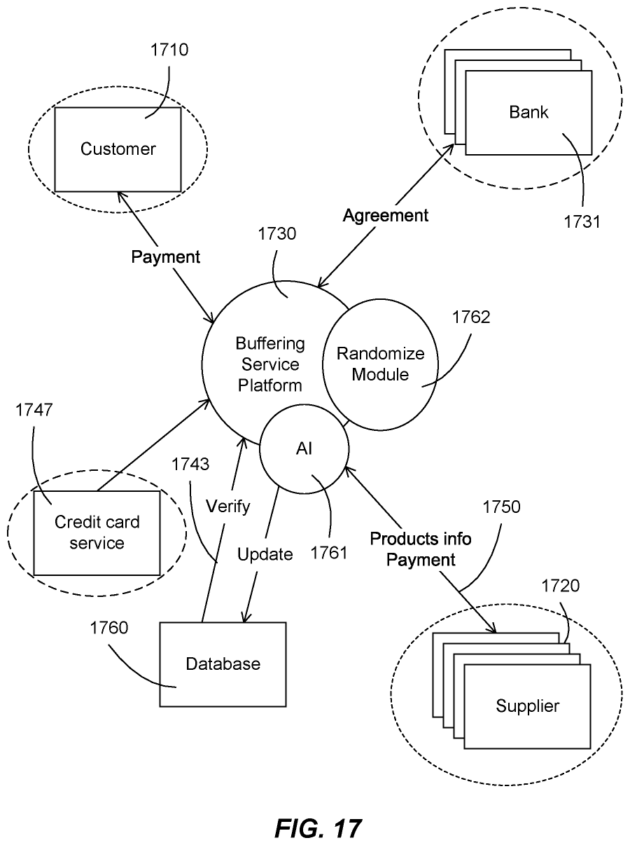

FIG. 17 illustrates a schematic of a buffering service platform according to some embodiments. The buffering service platform 1730 can be configured to receive payments from customers 1710, and then send another payment to suppliers 1720. The buffering service platform can include a constantly update database 1740 to know customer credit information, agreements with banks 1741 to generate credit or debit used for payment. The buffering service platform can include an AI module to process the data from the database to reduce the risk of fraudulent identities. The buffering service platform can include a randomizing module to randomly select a credit card, e.g., selecting one or more aspects of the credit cards issued by the banks as a result of the agreements. The buffering service platform can function as a one stop shop for customer in dealing with multiple suppliers, and can handle all post sale transactions for the suppliers. The buffering service platform can also function as a buffer for the suppliers, for example, to shield the suppliers from fraudulent transactions.

For example, a buffering service platform 1730 can be configured to provide products and services from one or more suppliers 1720 to customers 1710. In operation, upon receiving an inquiry from a customer, the platform can search inventories of the suppliers and then display the search results for the customer. The customer can select one or more products or services, and can proceed for payment, such as by a credit card. The platform can process the credit payment, using a database 1760, e.g., using data from the database to verify 1743 the authentication of the credit purchase, such as to the identity of the customer. In some embodiments, the platform 1730 can have an AI module 1761, which can be equipped with AI or machine learning, to assist in the analysis of the credit purchase.

The database 1740 can be updated with data from credit card services 1757, together with public and private data from social media or from banking institutions. The database can also be updated with data from the customers, e.g., by customer supplying information in a questionnaire or in agreement to have data stored in the database.

The platform can have agreements with one or more banks 1731 to issue credit cards, such as one-time-use credit cards. The platform can be configured to send 1750 another different payment to the supplier. The payment from the platform can be more secured than the payment from the customer, since the platform is known to the supplier, for example, through an agreement to display products or services on the platform. The payment can be a credit card payment, with the credit card selected among the credit cards issued by the banks 1731.

The platform can include a randomizing module 1762, which can be configured to randomly selecting a credit card among the available credit cards. For example, the random selection can be among the bin number of the credit card number, or can be among the credit number. The credit card can have the same card association and the card holder name as those of the customer.

The platform can be configured to handle all post sale transactions from the customer. The customer can communicate with the platform regarding issues related to the payment from the customer, such as a fraudulent transaction from a stolen credit card. The platform can settle the fraud charges with the customer, without involving the supplier. For issues related to the products or services obtained by the customer, such as a broken product or a poor-performance service, the platform can function as an intermediate or an arbiter between the customer and the supplier. For example, the platform can discuss the issues with the customer, and also discuss the issues with the supplier using the argument with the customer. Thus, the customer and the supplier can be seen as dealing only with the platform.

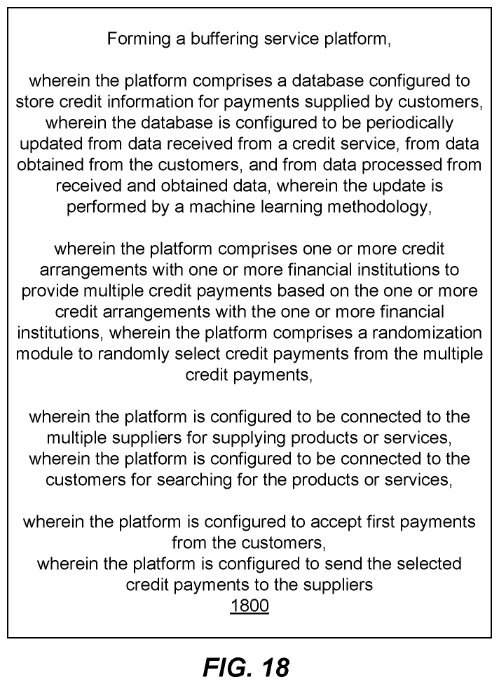

FIG. 18 illustrates a flow chart for forming a buffering service platform according to some embodiments. Operation 1800 forms a buffering service platform. The platform can include a database configured to store credit information for payments supplied by customers. The database can be configured to be periodically updated from data received from a credit service, from data obtained from the customers, and from data processed from received and obtained data. The update can be performed by a machine learning methodology. The platform can include one or more credit arrangements with one or more financial institutions to provide multiple credit payments based on the one or more credit arrangements with the one or more financial institutions. The platform can include a randomization module to randomly select credit payments from the multiple credit payments. The platform can be configured to be connected to the multiple suppliers for supplying products or services. The platform can be configured to be connected to the customers for searching for the products or services. The platform can be configured to accept first payments from the customers. The platform can be configured to send the selected credit payments to the suppliers.

In some embodiments, the buffering service platform can be used as a travel reservation platform in which the customers are configured to make travel reservations from travel suppliers such as airlines, car rental companies or hotel managements.

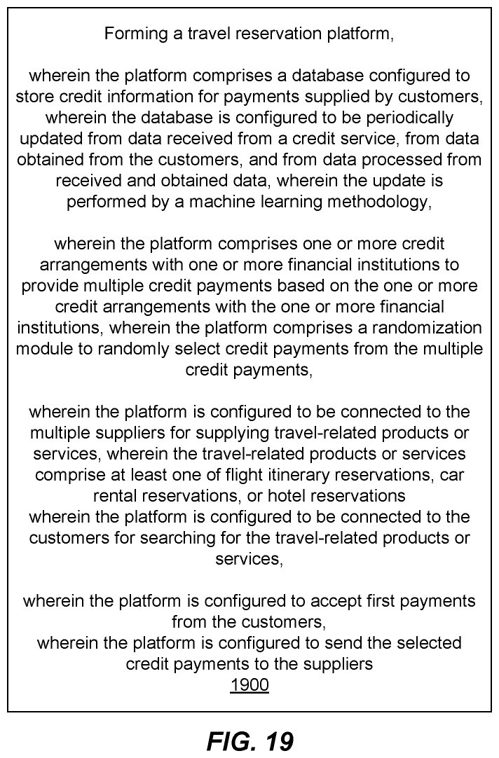

FIG. 19 illustrates a flow chart for forming a travel reservation platform according to some embodiments. Operation 1900 forms a travel reservation platform. The platform comprises a database configured to store credit information for payments supplied by customers. The database is configured to be periodically updated from data received from a credit service, from data obtained from the customers, and from data processed from received and obtained data. The update is performed by a machine learning methodology. The platform comprises one or more credit arrangements with one or more financial institutions to provide multiple credit payments based on the one or more credit arrangements with the one or more financial institutions. The platform comprises a randomization module to randomly select credit payments from the multiple credit payments. The platform is configured to be connected to the multiple suppliers for supplying travel-related products or services. The travel-related products or services comprise at least one of flight itinerary reservations, car rental reservations, or hotel reservations. The platform is configured to be connected to the customers for searching for the travel-related products or services. The platform is configured to accept first payments from the customers. The platform is configured to send the selected credit payments to the suppliers.

In some embodiments, the buffering service platform in general, or a travel reservation platform in particular, can be configured to function as a buffering service between customers and suppliers. From a financial point of view, the payment process from the customers to the suppliers can be divided into two distinct and separate payment processes. A first payment process is from the customers to the platform, in which the platform can perform credit verification, receive the payment, and handle post-sale transactions or disputes. A second payment process is from the platform to the suppliers, in which the platform can issue credit payments to the suppliers. The credit payments from the platform can come from prior credit agreements that the platform has with multiple financial institutions.

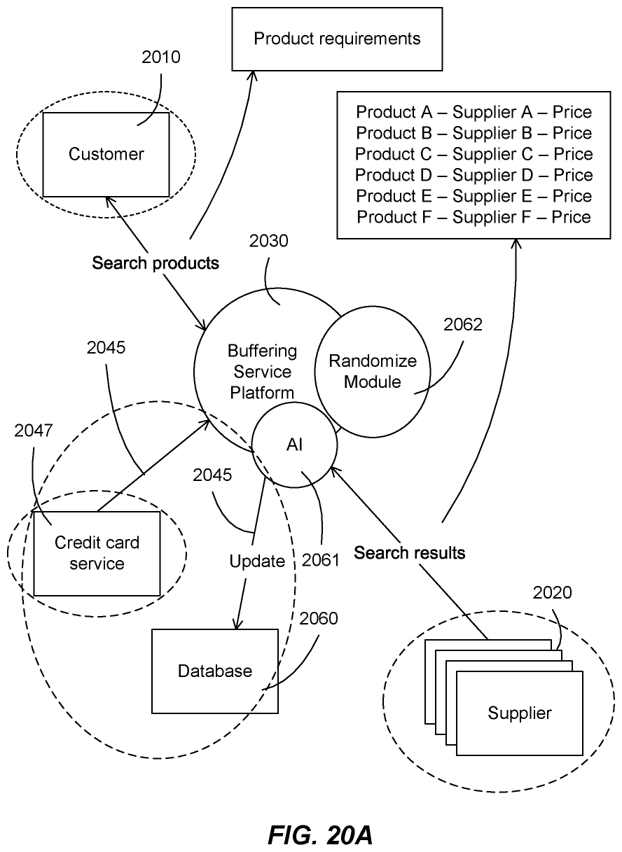

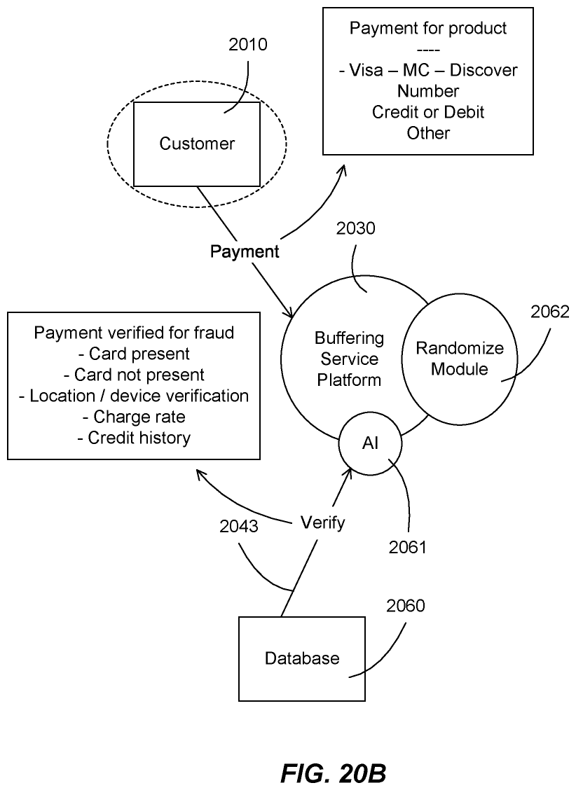

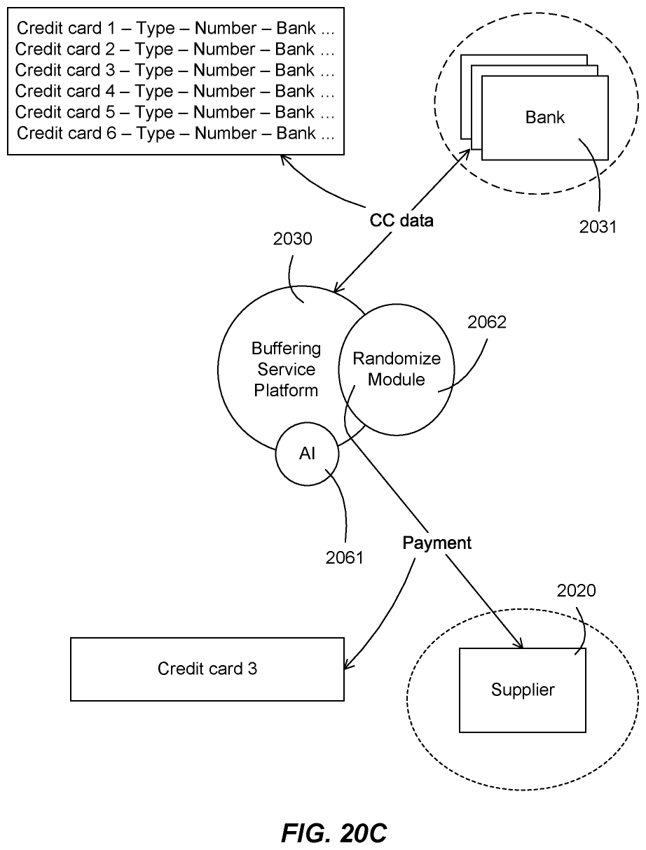

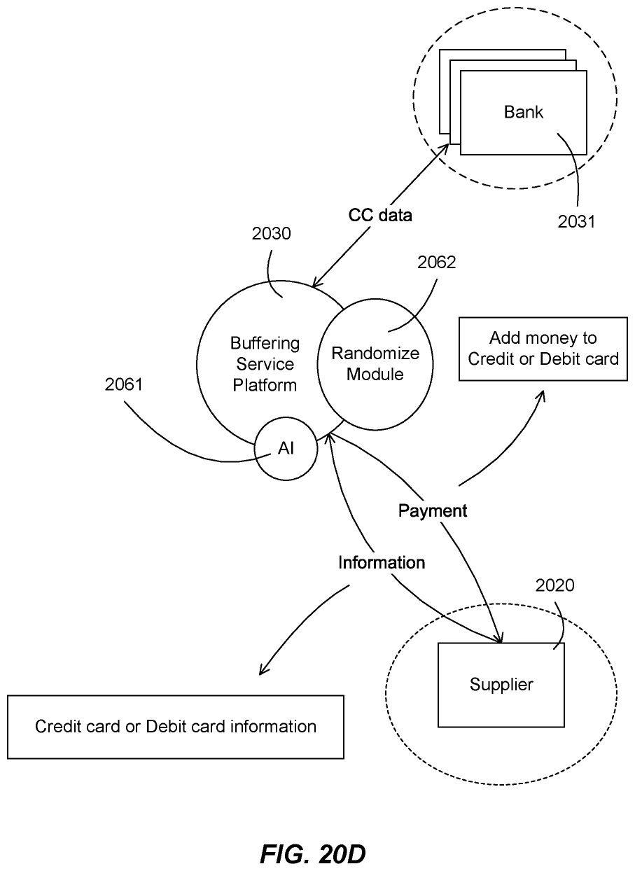

FIGS. 20A-20d illustrate operation schematics for a buffering service platform according to some embodiments. In FIG. 20A, a buffering service platform 2030 can be configured to provide products and services from one or more suppliers 2020 to customers 2010. In operation, a customer 2010 can send a search request for a product to the platform 2030. In some embodiments, the buffering service platform can be a platform configured to sell products or services on-line or through a network such as the Internet. For example, the platform can be a travel reservation platform, with the suppliers being the individual airlines or airline networks such as GDS, or bus or train services, or car rental companies, or lodging accommodation such as hotel companies or airbnb. The travel reservation platform can be linked to customers looking to make travel reservations, such as looking to book an air flight, reserving a car rental, and a hotel for the duration of the travel.

The search request can include requirements for the product, such as the name or description of the product to be searched. For example, in the case of the travel reservation platform, the search request can be an air flight search, and can include the departure and arrival locations, together with the date of travel.

The platform, linked to inventories of the suppliers 2020, can then perform a search on the inventories and then returns the search results to be displayed on the customer system. For example, the search results can include a list of products matching the requirements of the search request, together with the name of the supplier, the price of the products, and other information such as descriptions and reviews for the products. In the case of the travel reservation platform, the search results can include a list of flight itineraries having the departure and arrival locations and the date of travel matching the requirements of the flight search request. The list of flight itineraries can include the airline operating the air flight, and the price of the air flight, together with other information such as no stop, one stop, and layover time.

In FIG. 20B, the customer can select one or more products or services, and can proceed for payment, such as by a credit card. For example, in the case of the travel reservation platform, the customer can select a flight itinerary, and then perform a check out to open a payment screen. The customer then can select a payment method, such as paying by a credit card or by a debit card. The customer then can enter the required information, such as the name on the card, the card number, the expiration date, and optionally the CVC code.

The platform can process the credit payment, using a database 2060, e.g., using data from the database to verify 2043 the authentication of the credit purchase, such as to the identity of the customer. The platform can use additional authentication security steps, such as obtaining location and machine identification of the customer during the payment transaction. The platform can use an AI module 2061, which can be equipped with AI or machine learning, to assist in the analysis of the authentication process, such as to match the additional authentication security steps, and to analyze the characteristics of the credit card purchase against the spending behavior or patterns derived from the historical data of the customer stored in the database.

The database 2040 can be updated with data from credit card services 2057, together with public and private data from social media or from banking institutions. The database can also be updated with data from the customers, e.g., by customer supplying information in a questionnaire or in agreement to have data stored in the database. With the AI assisted authentication process using additional authentication security steps and the constantly updated database, the platform can be confident about the determined risk of fraudulent identity, such as in the case of stolen credit cards.

In some embodiments, the platform is confident enough about its ability to detect fraudulent identity to assume the financial risk of accepting the credit payment from the customer. To assume the financial risk, the platform can receive the customer payment, and then using the platform credit to send a different payment to the supplier.

In some embodiments, the present invention discloses a two-step payment process, which can include a first payment from the customer to the platform, and a second payment from the platform to the supplier, to replace the one step payment process of the customer sending payment to the supplier through the platform.

In FIG. 20C, the platform can have agreements with one or more banks 2031 to issue credit or debit cards, such as one-time-use credit cards. For example, the banks can issue the platform with a list of credit or debit cards, including the credit or debit card number (card association number, bin number, account number, and check sum number). The list of credit or debit cards can include the card association and the issuing bank. The credit or debit cards can include regular credit cards, secured credit cards, credit cards with allowable balance (e.g., balance credit cards), or preload debit cards.

The platform can be configured to send 2050 a payment to the supplier. The payment from the platform to the supplier is different from the payment from the customer to the platform. For example, the payment from the platform can be more secured than the payment from the customer, since the platform is known to the supplier, for example, through an agreement to display products or services on the platform. The payment can be a credit or debit card payment, with the credit or debit card selected among the credit or debit cards issued by the banks 2031.

The platform can include a randomizing module 2062, which can be configured to randomly selecting a credit or debit card among the available credit or debit cards. For example, the random selection can be among the bin number of the credit card number, or can be among other numbers of the credit number. The credit card can have the same card association and the card holder name as those of the customer.

In some embodiments, the randomization can be configured to avoid automatic fraud detection in some credit card processing services, which can automatically flag the payment as fraud when observing a repetition, such as detecting multiple credit cards having a same characteristic in a short time period.

FIG. 20D shows an alternative payment process from the platform to the supplier. The platform can have agreements with one or more banks 2031 to issue credit or debit cards, such as one-time-use credit cards, including transferring funds into the security of a secured credit card, transferring funds as a balance into a balance credit card, or transferring funds into a preload debit card.

The platform can be configured to send a payment to the supplier using information supplied by the supplier. For example, the supplier can provide the platform with information regarding a credit card or a debit card that the supplier wants the platform to use. The platform then can send payment, in the form of a balance if the supplier provides a balance credit card, in the form of a preload debit card if the supplier provides a debit card.

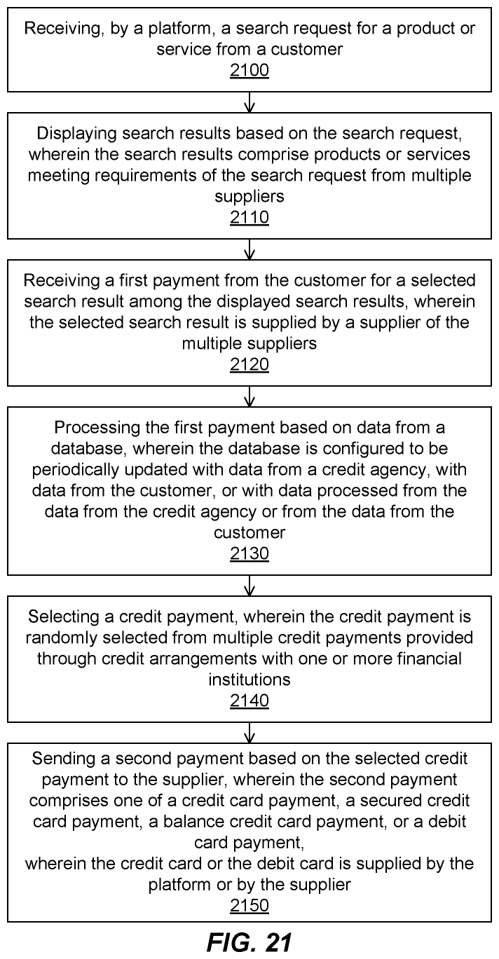

FIG. 21 illustrates a flow chart for operating a buffering service platform according to some embodiments. Operation 2100 receives, by a platform, a search request for a product or service from a customer. Operation 2110 displays search results based on the search request, with the search results showing products or services meeting requirements of the search request from multiple suppliers. Operation 2120 receives a first payment from the customer for a selected search result among the displayed search results, with the selected search result supplied by a supplier of the multiple suppliers. Operation 2130 processes the first payment based on data from a database. The database is configured to be periodically updated with data from a credit agency, with data from the customer, or with data processed from the data from the credit agency or from the data from the customer. Operation 2140 selects a credit payment, wherein the credit payment is randomly selected from multiple credit payments provided through credit arrangements with one or more financial institutions. Operation 2150 sends a second payment based on the selected credit payment to the supplier, wherein the second payment comprises one of a credit card payment, a secured credit card payment, a balance credit card payment, or a debit card payment, with the credit card or the debit card supplied by the platform or by the supplier.

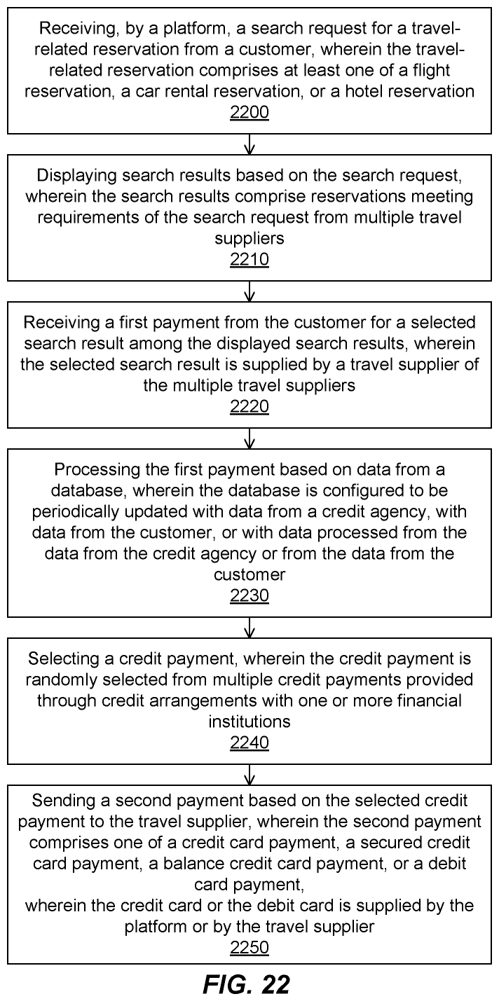

FIG. 22 illustrates a flow chart for operating a travel reservation platform according to some embodiments. Operation 2200 receives, by a platform, a search request for a travel-related reservation from a customer, with the travel-related reservation including at least one of a flight reservation, a car rental reservation, or a hotel reservation. Operation 2210 displays search results based on the search request, with the search results showing reservations meeting requirements of the search request from multiple travel suppliers. Operation 2220 receives a first payment from the customer for a selected search result among the displayed search results, with the selected search result supplied by a travel supplier of the multiple travel suppliers. Operation 2230 processes the first payment based on data from a database, with the database configured to be periodically updated with data from a credit agency, with data from the customer, or with data processed from the data from the credit agency or from the data from the customer. Operation 2240 selects a credit payment, with the credit payment optionally randomly selected from multiple credit payments provided through credit arrangements with one or more financial institutions. Operation 2250 sends a second payment based on the selected credit payment to the travel supplier. The second payment can include one of a credit card payment, a secured credit card payment, a balance credit card payment, or a debit card payment, with the credit card or the debit card supplied by the platform or by the travel supplier.

In some embodiments, the present invention discloses a computer program having machine-readable instructions to cause a processing device to implement any one of the methods described above. The present invention also discloses a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, or a nonvolatile electronic memory. The software program may be run on a variety of devices, including a processor or a processing device to perform any one of the methods described above.

In some embodiments, the methods can be realized in hardware, software, or a combination of hardware and software. The methods can include computer-implemented methods, using a computer or a data processing system to execute the methods, including executing operations by a hardware processor. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

In some embodiments, the present invention discloses a system having a non-transitory memory and one or more hardware processors coupled to the non-transitory memory and configured to read instructions from the non-transitory memory to cause the system to perform operations necessary to perform the methods described above.

The terms “computer program”, “software”, “application”, variants and/or combinations thereof, in the context of the present specification, mean any expression, in any language, code or notation, of a set of instructions intended to cause a system having an information processing capability to perform a particular function directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

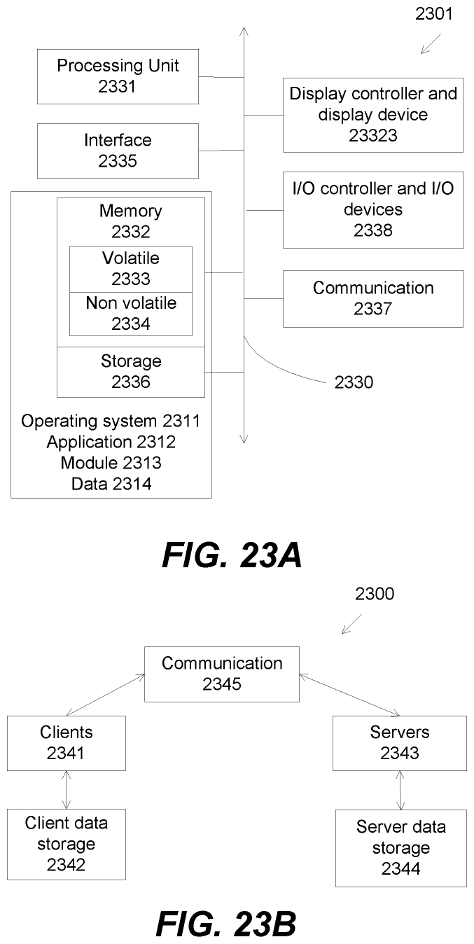

FIGS. 23A-23B illustrate computing environments according to some embodiments.

FIG. 23A shows a computing environment. An exemplary environment for implementing various aspects of the invention includes a computer 2301, comprising a processing unit 2331, a system memory 2332, and a system bus 2330. The processing unit 2331 can be any of various available processors, such as single microprocessor, dual microprocessors or other multiprocessor architectures. The system bus 2330 can be any type of bus structures or architectures. The system memory 2332 can include volatile memory 2333 and nonvolatile memory 2334.

Computer 2301 also includes storage media 2336, including removable storage media or nonremovable storage media, and volatile or nonvolatile disk storage. A removable or nonremovable interface 2335 can be used to facilitate connection. These storage devices can be considered as part of the I/O device 2338 or at least they can be connected via the bus 2330. Storage devices that are “on board” generally include EEPROM used to store the BIOS.

The computer system 2301 further can include software to operate in the environment, such as an operating system 2311, system applications 2312, program modules 2313 and program data 2314, which are stored either in system memory 2332 or on disk storage 2336. Various operating systems or combinations of operating systems can be used.

Input devices can be used to enter commands or data, and can include a pointing device such as a mouse, stylus, touch pad, and other devices such as keyboard, microphone, connected through interface ports 2338. Interface ports 2338 can include connection ports, such as serial ports, parallel ports, or universal serial buses (USB). The interface ports 2338 can also accommodate output devices. For example, a USB port may be used to provide input to computer 2301 and to output information from computer 2301 to an output device. Output adapter 2339, such as video or sound cards, is provided to connect to some output devices such as monitors, speakers, and printers.

Computer 2301 can operate in a networked environment with remote computers. The remote computers, including a memory storage device, can be a data processing system, such as a personal computer, or a workstation, and typically includes many or all of the elements described relative to computer 2301. Remote computers can be connected to computer 2301 through a network interface 2335 and communication connection 2337, with wire or wireless connections. Network interface 2335 can be communication networks such as local-area networks (LAN), wide area networks (WAN) or wireless connection networks.

FIG. 23B shows a schematic block diagram of a sample computing environment with which the present invention can interact. The system 2300 includes a plurality of client systems 2341. The system 2300 also includes a plurality of servers 2343. The servers 2343 can be used to employ the present invention. The system 2300 includes a communication network 2345 to facilitate communications between the clients 2341 and the servers 2343. Client data storage 2342, connected to client system 2341, can store information locally. Similarly, the server 2343 can include server data storages 2344.

Profile with User Behavior

In some embodiments, data from the customers can assist determine fraudulent activities. For example, forming and updating a user behavior profile by the actions of the customers and by the communication of the customer with the platform can provide a pattern of the customer behavior. The platform can use an AI algorithm to determine if the current action or communication of the customer is inconsistent or deviated from the past behavior pattern. The deviation thus can signal a potentially fraudulent activity.

In some embodiments, products and services are provided to customers by a platform, e.g., a system running on a server. The products and services can display the search results of an inputted inquiry of a customer, e.g., multiple products or services meeting the input criterion, into different configurations and presentations, together with allowing the customers to re-arrange and to filter the products or services. The arrangeable and filterable display of the products or services can allow the customers to select the optimum product or service, e.g., the product or service most suitable to the customers need.

For example, the customer can arrange the search products according to price or brands, or the customer can identify certain features of the products in order to emphasize or remove selected products. The switching between different configurations and presentations can be performed using saved search results, without the need for updating for every single change. In addition, after a certain period, the search results can be automatically updated, allowing the customer to have access to the latest product information.

Communication information of the customer during the product selection session, together with actions of the customers during the product selection can be saved in a user behavior profile, together with indications of user behavior determined from the communication information and the actions. The actions of the customers can include price selections, brand selections, or the selections of other features of the products. Indications of the customer behavior can be derived from the actions, such as low price selections or a deselection of luxury brands can indicate a customer frugality, while a disregard for prices can indicate a customer high comfort value.

The communication information can include the device used by the customer, the Internet Protocol (IP) addresses, the login time and location, together with the mouse and keyboard usage of the customer. The access to the communication information used by the customer can provide indications of the customer behavior, such as a long delay time before a high price selection can indicate a reluctance of the customer for high price products, multiple login times during after business hour can indicate a customer having a normal working schedule, or consistent IP addresses and login locations can indicate a less traveled customer.

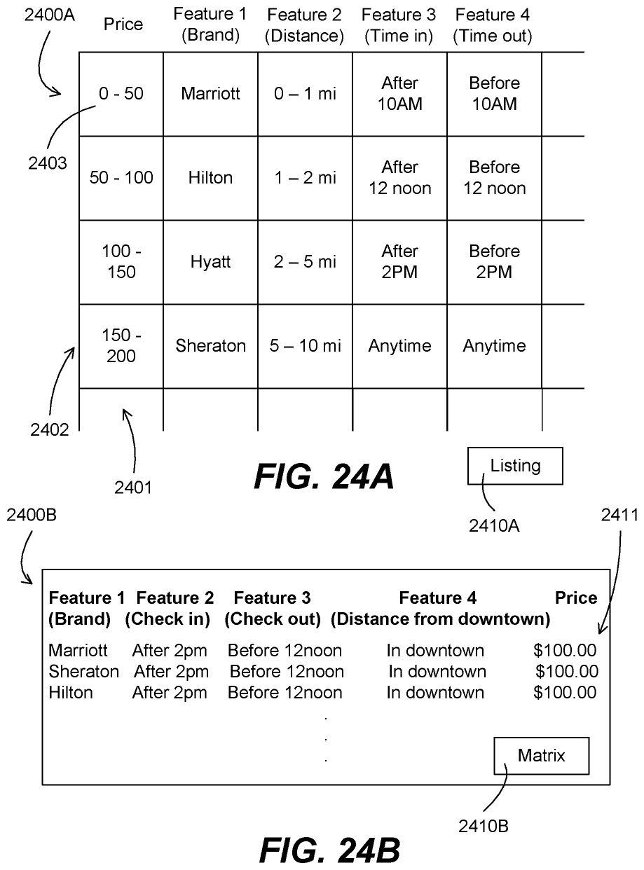

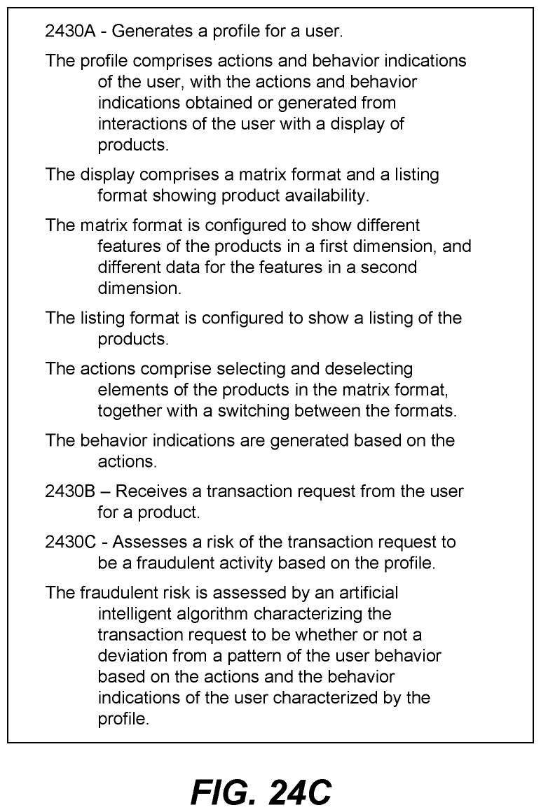

FIGS. 24A-24C illustrate display configurations for the search results of a hotel according to some embodiments. In FIG. 24A, the results of a search for a hotel, which include multiple accommodation places, can be displayed in a matrix format 2400A. Different categories or features of the search results can be shown in columns 2401, such as a price column, a brand column for showing the brand name of the hotels, a distance column for showing the distance between the hotel and a downtown location, a check in time column for showing the check in time of the hotel, a check out time for showing the checkout time of the hotel. Other categories can also be shown, such as the availability of amenities such as parking, wifi, breakfast, bar or lounge, fitness center. In the figure, the features are included for illustration purpose, and not a complete set of categories for hotel features and amenities.

The matrix 2400A can include rows 2402, which can show different data for different features, e.g., columns 2401 of the matrix. For example, row 1 of the column price, e.g., element 2403 of matrix 2400A, which is the intersecting element of column 1 and row 1, shows the price range of 0-50, row 2 of the column price shows the price range of 50-100, etc. Similarly, row 1 of the hotel name shows the name of a hotel, such as Marriott, row 2 of the hotel name shows the hotel name of Hilton, etc.

The results of a search for a hotel can be displayed in different formats, such as three dimensional matrices, or in a tile configuration. There can be a switch button 2410A, which can be used for switching from the 2D matrix format 2400A to another format, such as to the listing format 2400B.

In FIG. 24B, the results of a search for a hotel can be displayed in a listing format 2400B. In the listing format, multiple hotels 2411 can be shown, with each hotel listing shown elements or features of the hotel. There can be other listing formats, which are discussed in later sections. There can be a switch button 2410B, which can be used for switching from the listing format 2400B to another format, such as to the matrix format 2400A.

Displays for other products or services can be used, such as for car rental, flight travel plan, or other products or services.

FIG. 24C shows a flow chart for using a behavior profile to assess a fraudulent risk. Operation 2430A generates a profile for a user. The profile comprises communication information, actions and behavior indications of the user, with the communication information, actions and behavior indications obtained or generated from interactions of the user with a display of products. The display comprises a matrix format and a listing format showing product availability. The matrix format is configured to show different features of the products in a first dimension, and different data for the features in a second dimension. The listing format is configured to show a listing of the products. The actions comprise selecting and deselecting elements of the products in the matrix format, together with a switching between the formats. The behavior indications are generated based on the actions.

Operation 2430B receives a transaction request from the user for a product. Operation 2430C assesses a risk of the transaction request to be a fraudulent activity based on the profile. The fraudulent risk is assessed by an artificial intelligent algorithm characterizing the transaction request to be whether or not a deviation from a pattern of the user behavior based on the actions and the behavior indications of the user characterized by the profile.

### Profile for Traveling Services

In some embodiments, the display can be used for travel agency services, after receiving a travel plan as an input. The travel plan can include the date and places of traveling. For example, a customer can specify a departure and an arrival airport. Alternatively, the customer can specify a departure city and an arrival city, and the travel agency services can look up the nearby airports. In some embodiments, multiple airports can be used as input for the travel plan. For example, a customer can specify JFK airport or New York City as an arrival destination. The travel agency services can also include La Guardia airport and Newark airport, in addition to JFK airport, as the destination airport.

The travel agency services can perform a search for flight itineraries on the input date connecting the departure and arrival locations. The search results can be displayed in a multiple dimensional output such as a matrix. For example, one dimension of the multiple dimensional outputs, such as the columns of the matrix of the search results, can show different categories of the flight itineraries resulted from the search. The first column can show a first category, the second column can show the second category, until the last column showing the last category of the matrix. The categories can include price, departure time, date and airport, arrival time, date, and airport, travel time, layover time, number of flight segment, airlines, and other information such as early boarding, preferred seating, airline lounge access, lie-flat seats, Wi-Fi on international services, and new aircraft with more leg room.

Another dimension of the multiple dimensional outputs, such as the rows of the matrix of the search results, can show different data for the categories, such as different ranges or different values. Different elements, e.g., different rows, in a column of the matrix can show different data of the category representing in the column. For example, in the category of “price”, different price ranges, such as 100-200, 200-300, etc., can be listed in different rows. In the airline category, different airline names, such as American Airlines, United, etc., can be listed in different rows.

Different display outputs can be used, such as a matrix having rows as categories and columns as data of the categories. The matrix can be two dimensional, with the columns of the matrix showing the categories of the matrix, and the rows of the matrix showing the data of the categories.

Folded or wrapped matrix can be used, such as the categories can occupy two (or more) rows. The category can be split into two category lists. The odd row (first row, third row, etc.) can correspond to the first category list, and the even row (second row, fourth row, etc.) can correspond to the second category list. For example, a wrapped matrix with 2 adjacent rows can be used for a row dimension, e.g., x direction. The first row can include price, departure date and time, arrival date and time, flight time, travel time, layover time, and airlines. The second row can include other information, such as the availability of early boarding, preferred seating, airline lounge access, lie-flat seats, Wi-Fi on international services, and leg room dimension. Thus the odd rows of the matrix, e.g., row 3, row 5, etc., can include data for the first row, such as price range, departure time range, etc. The even rows of the matrix, e.g., row 4, row 6, etc., can include data for the second row, such as yes for early boarding, no for preferred seating, etc.

In some embodiments, matrix configurations with more than 2 dimensions can be used, such as three dimensional matrices, with the third dimension representing additional information from the search results.

Other display output formats can be used, such as a tile and bucket format. The search results can be displayed in multiple tiles, which can be configured in a two dimensional configuration, with each data in a bucket. The tile configuration can be similar to a matrix, with each bucket corresponds to an element of the matrix.

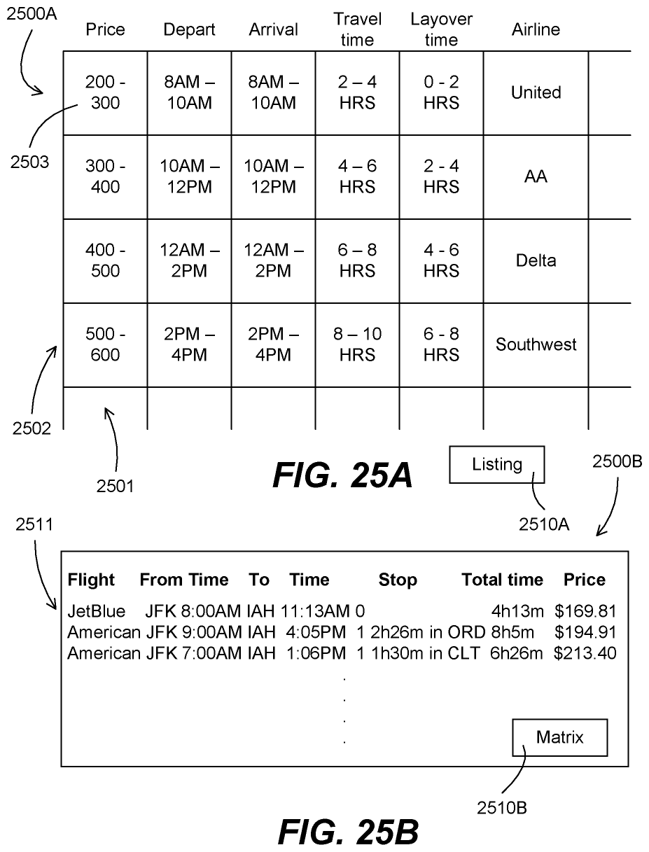

FIGS. 25A-25B illustrate display configurations for the search results of a travel plan according to some embodiments. In FIG. 25B, the results of a search for a travel plan, which include multiple flight itineraries, can be displayed in a matrix format 2500A. Different categories of the search results can be shown in columns 2501, such as a price column, a departure column for showing the time of departure, or optionally a date or a range of dates of departure, an arrival column for showing the time of arrival, or optionally a date or a range of dates of arrival, a travel time column for showing the total travel time, a layover time for showing the waiting time between flight segments, an airline column for showing the name of the airlines operating the flight itineraries. Other categories can also be shown, such as the availability of flight amenities such as early boarding, preferred seating, airline lounge access, lie-flat seats, Wi-Fi on international services, and new aircraft with more leg room. In the figure, the categories are included for illustration purpose, and not a complete set of categories for flight itineraries. For example, the departure column can include the date of travel (including a range of the possible travel dates) and the departure airport, in addition to the time of travel. The travel time can be the flight time instead of the total travel time, e.g., the total travel time can be calculated by adding the flight time and the layover time. Additional columns representing additional categories can be included, such as departure and arrival airports.

The matrix 2500A can include rows 2502, which can show different data for different categories, e.g., columns 2501 of the matrix. For example, row 1 of the column price, e.g., element 2503 of matrix 2500A, which is the intersecting element of column 1 and row 1, shows the price range of 200-300, row 2 of the column price shows the price range of 300-400, etc. Similarly, row 1 of the column departure shows the time range of 8 am-10 am, row 2 of the column departure shows the time range of 10 am-12 am, etc. Alternatively, the departure column can show ranges of the dates, such as row 1 showing March 1st to March 2nd, row 2 showing March 3rd to March 4th, etc. Generally, the customer has decided on the date of travel, and thus the time ranges of that date can be shown, so that the customer can select the most suitable or desirable times. In some cases, there is no need for a precise travel date, and thus the customer can look for different flight itineraries for a range of dates, for example, to choose the best possible flight itineraries. Row 1 of the column airline show the airline United, row 2 of the column airline show the airline American Airlines, etc.

The results of a search for a travel plan can be displayed in different formats, such as three dimensional matrices, e.g., the third dimension can be underneath or on top of the displayed 2d matrix. The third dimension matrices can be accessed, for example, by peeling away the top matrices. For example, the customer can slide the displayed matrix away to expose the under layer matrix. The results of a search for a travel plan can be displayed in a tile configuration, which can be similar to the matrix configuration. Information can be displayed in buckets of the tile configuration, with the buckets similar to the elements of the matrix.

There can be a switch button 2510A, which can be used for switching from the 2D matrix format 2500A to another format, such as to the itinerary format 2500B.

In FIG. 25B, the results of a search for a travel plan can be displayed in a flight itinerary format 2500B. In the flight itinerary format, multiple flight itineraries 2511 can be shown, with each flight itinerary shown elements of the flight itinerary. There can be other itinerary formats, which are discussed in later sections. There can be a switch button 2510B, which can be used for switching from the flight itinerary format 2500B to another format, such as to the matrix format 2500A.

In some embodiments, the display of the search results can be filtered to provide suitable flight itineraries according to a customer desire. For example, the flight matrix, e.g., the matrix containing information of the flight itineraries that are the results of the search for the travel plan, can be filtered, using a customer input, such as a saved customer preference or an interactive customer action, to remove elements of the flight matrix according to the customer input.

The customer input can be a positive input, e.g., a selection, or a desired or a selected characteristic of flight itineraries, and thus flight itineraries not meeting the positive customer input can be removed. The customer input can be a negative input, e.g., a deselection, or a non-desired or an unselected characteristic of flight itineraries, and thus flight itineraries meeting the negative customer input can be removed. The removal can be performed by taking out the flight itineraries, or by making the corresponding flight itineraries not selectable or not viewable, such as graying out these flights.

The customer input can be a cancel input, meaning the current input can cancel the earlier input. For example, a customer input can be a selection of United airlines. The flight matrix can be filtered to only show the flight itineraries of United airlines. A new input can be a cancellation of the previous selection of American airlines. The flight matrix can be filtered to show the flight itineraries of other airlines instead of just United airlines.

The customer input can be a supersede input, meaning the current input can replace the earlier input. For example, a customer input can be a selection of United airlines. The flight matrix can be filtered to only show the flight itineraries of United airlines. A new input can be a selection of American airlines. If the new input is a supersede input, the selection of American airlines can replace the earlier selection of United airlines. The flight matrix can be filtered to show the flight itineraries of American airlines.

The customer input can be an OR input, meaning the previously filtered flight matrix having flights having the previous input can be enlarged to include flights having the current input. Or the flight matrix can be filtered with the previous input or the current input, e.g., the flight matrix can be filtered to provide flights having the previous input or the current input. For example, a customer input can be a selection of United airlines. The flight matrix can be filtered to only show the flight itineraries of United airlines. A new input can be a selection of American airlines. If the new input is an OR input, the flight matrix can be filtered to show the flight itineraries of both United airlines and American airlines, e.g., the customer input is to show flights from either United airlines or American airlines.

The customer input can be an AND input, meaning the previously filtered flight matrix having flights having the previous input can be narrowed to include flights having both the previous input and the current input. For example, a customer input can be a selection of United airlines. The flight matrix can be filtered to only show the flight itineraries of United airlines. A new input can be a selection of layover time less than 2 hours. If the new input is an AND input, the flight matrix can be filtered to show the flight itineraries of United airlines having layover time less than 2 hours.

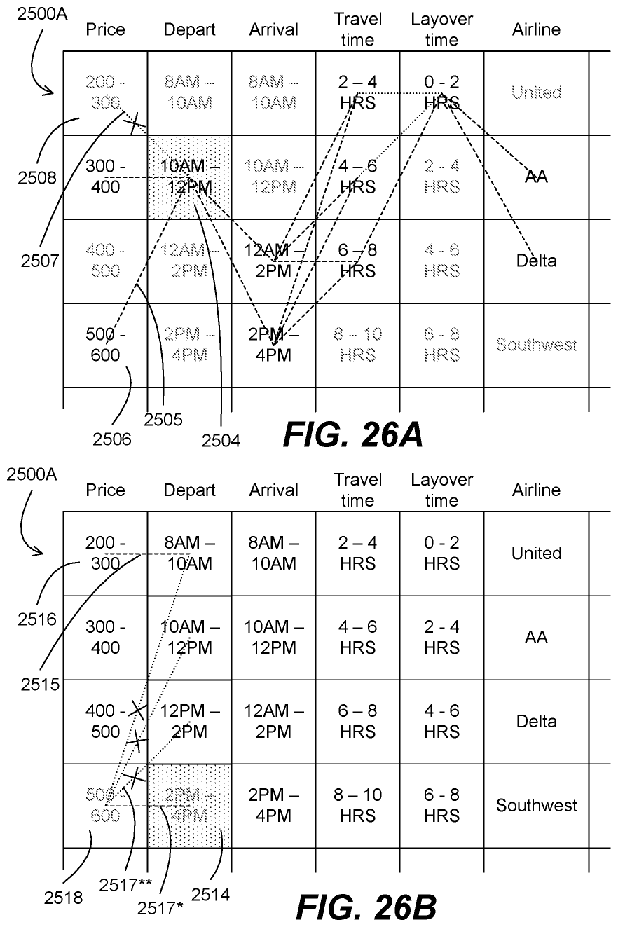

FIGS. 26A-26B illustrate positive and negative selection processes for a flight matrix according to some embodiments. A flight matrix can be a presentation of the search results for a travel plan. In the flight matrix, categories of the flight itineraries and data of the categories can be included, which can allow a customer to view the possible flight itineraries in a visual display. The flight matrix can include a list, e.g., a two dimensional list, of the characteristics of the flight itineraries resulted from the search results of the inputted travel plan.

The number of flight itineraries can be high, e.g., can be a hundred or two of possible flights connecting two locations at the date specified. Thus a selection of suitable flights can be performed to provide the optimum flights for the customer.

The selection can be a positive selection, meaning selecting a desired characteristic of the flight itineraries. The selection can be a negative selection, meaning selecting a non-desired characteristic of the flight itineraries, or a characteristic that the selected flight itineraries should not have. In addition, a subsequent selection can cancel or undo a previous selection, or can supersede the previous selection. The multiple selections can be OR selections, e.g., the selected flight itineraries can have the characteristics specified in either selections, or the selected flight itineraries need to satisfy only one selection characteristic. The multiple selections can be AND selections, e.g., each of the selected flight itineraries will have all characteristics specified by the multiple selections.

A positive selection, or simply a selection since the default for selection is a positive selection, can be performed on a flight matrix.

An element of the matrix can be selected, for example, as an input from the customer. The selection can be marked as a positive selection, meaning the selection is for desired characteristics of the suitable flights. The marking can be automatic, e.g., inherited from a previous selection characteristic. The marking can be manual, e.g., the customer can choose from a menu, stating that the current selection is positive. Alternatively, after making the selection, a menu can pop up, asking for a choice of characteristics of the current selection, such as positive selection, negative selection, supersede selection, AND selection, or OR selection. For example, the selected element can include a choice for preferred airlines, such as Southwest airline.

After the positive selection, such as a choice for a preferred airline, such as Southwest airline, the flight matrix can be marked or updated based on the selected element, e.g., elements of the flight matrix can be marked as whether or not having a flight satisfying the selected matrix element. For example, an element of the flight matrix is marked as having a flight if there is at least a flight itinerary that also has information of the selected element, e.g., having information of both elements. As a specific example, if the selected element is Southwest airline, then an element of the flight matrix containing a departure time between 10 and 12 can be marked as having a flight if there is a Southwest flight departing between 10 and 12.

An element of the flight matrix can be marked as not having flight if there is no flight itinerary meeting information of both elements. As a specific example, if the selected element is Southwest airline, then an element of the flight matrix containing a departure time between 2 and 4 can be marked as not having a flight if there is no Southwest flight departing between 2 and 4.

In some embodiments, the marking of the matrix elements can be performed on the display matrix or on the saved search results of flight itineraries. Thus there is no updating of flight information, and the performance of the server can be instantaneous. Alternatively, the flight matrix can be updated after the selection.

FIG. 26A shows a positive selection 2504 on a flight matrix 2500A. The flight matrix 2500A can present a list of characteristics of possible flight itineraries, for example, the price ranges, the departure time, the arrival time, the travel time, the layover time, the airlines operating the flight, etc. A selection 2504 can be performed, which can be a positive selection. There can be a menu, not shown, listing the choices of selection, such as positive, negative, cancel, supersede, OR, and AND selections. For example, the menu can be shown next to the flight matrix, with the default choice for the selection highlighted. Alternatively, after selecting an element of the matrix, a menu can be popped-up, asking for the choice of selections.

The positive selection 2504 can select a departure time of between 10 and 12 in the morning. The flight itineraries that do not meet the selection, e.g., the flights that do not depart between 10 and 12, can be removed from the flight matrix or can be removed from being further selected. The flight itineraries that meet the selection, e.g., the flights that depart between 10 and 12, can remain or can be highlighted, for example, for further selection.

For example, after the selection of element 10 AM-12 AM on departure category, elements 2508 can be grayed out, meaning there is no 200-300 flight 2507 departing between 10 and 12. The remaining elements 2506 can stay the same, meaning there is at least a 500-600 flight 2505 departing between 10 and 12. Thus the flight matrix has been filtered, separating the flights meeting the selection characteristics and the flights not meeting the selection characteristics. Other formats can be used for the separation of flights meeting and not meeting the selections, such as highlighting the flights elements meeting selection characteristics (such as highlighting element 2506), and leaving alone the elements not meeting selection characteristics (such as not touching or not changing element 2508).

A negative selection, or a deselection, can be performed on a flight matrix. An element of the matrix can be deselected, for example, as an input from the customer. After the negative selection, e.g., a deselection of a matrix element, such as a selection of an airline that the customer prefers not to use, such as Southwest airline, the flight matrix can be marked or updated based on the deselected element, e.g., elements of the flight matrix can be marked as whether or not having a flight excluding the deselected matrix element. For example, an element of the flight matrix is marked as having a flight if there is a flight itinerary that does not contain the deselected element. As a specific example, if the deselected element is Southwest airline, then an element of the flight matrix containing a departure time between 10 and 12 can be marked as having a flight if there is a non-Southwest flight departing between 10 and 12.

An element of the flight matrix can be marked as not having flight if all flights meet the deselected element. As a specific example, if the deselected element is Southwest airline, then an element of the flight matrix containing a departure time between 2 and 4 can be marked as not having a flight if all flights departing between 2 and 4 are Southwest.

FIG. 26B shows a negative selection 2514, e.g., a deselection 2514, on a flight matrix 2500A. The deselection process, or the negative selection process, can include a selection together with a selected choice of negative selection. For example, after selecting an element of the matrix, there can be a menu listing the choices for the selection, such as positive, negative, cancel, supersede, OR, and AND selections.

In a negative selection process, the selected element can be considered as an undesired characteristic of suitable flight itineraries. Alternatively, the negative selected element can be considered as having lowest priority in the list of suitable flight itineraries. Thus when a negative selection is performed, all flight itineraries that contain the information in the negative element can be removed from the flight matrix.

In a flight matrix 2500A, the element 2514 of 2-4 departure time can be unselected, e.g., negative selection, or selected to be not a desired characteristic of suitable flight itineraries. The matrix can be filtered, e.g., other elements of the matrix can be marked as having flight or not having flight according to the selection 2505. For example, element 2516 can be marked as having flight, such as highlighting the element or remaining an unaffected element, if there is at least a flight 2515 at a price range of 200-300 that departs at a time different than the time range 2-4, such as departing at a time range 8-10. The element 2518 of 500-600 can be marked as not having flight, such as grayed out, if there is no flight 2517** having a price of 500-600 and departing at a time different than 2-4, such as the only 500-600 flight 2517* departs at 2-4.

Subsequent selections can be positive or negative selections. Further, the subsequent selections can be a cancel or supersede selection, e.g., canceling or replacing the previous selections, AND selections, e.g., flights must satisfy both selections, and OR selections, e.g., flights that can satisfy either selections.

In a cancel selection, the customer can select the already-selected element again. The re-selection can toggle the selection to cancel the selection. Alternatively, the customer can select an element, and then select a cancellation choice. The selection of the already-selected element is canceled, and the elements of the flight matrix are returned to the previous states, e.g., in the states before the already-selected element is selected.

In a supersede selection, the customer can select an element and then choose the option of supersede. For example, the customer can select the already-selected element, and choose an option different than that of the already-selected element. As a specific example, the already-selected element can be a positive selection. The customer can select the element again, then choose the option of negative selection, which operates to supersede the previously selected positive selection. Alternatively, the customer can select a new element, and choose a choice of supersede, such as supersede positive or supersede negative.

The supersede selection is equivalent to a cancellation, plus a selection of the subsequent element, such as a positive or a negative selection of the second element. Thus, after a cancellation to return the matrix to its original state, the matrix can be re-sorted according to the new supersede selection.

For example, the selected first positive element can be Southwest airline. The customer can change his selection, e.g., using a subsequent selection to replace the previous positive selection, such as by selecting United Airlines as the second positive element with the identification of the second element being the superseded element. The elements of the flight matrix are then subjected to the positive selection of United airlines, e.g., the elements of the flight matrix can be marked as whether or not having a United flight.

Alternatively, the customer can change his selection, such as selecting American airlines as the second negative element as superseding the selected first positive element of Southwest airline. The elements of the flight matrix are then subjected to the negative selection of American airlines, e.g., the elements of the flight matrix can be marked as not being or being an American flight, as discussed above with regard to a negative selection or a deselection.

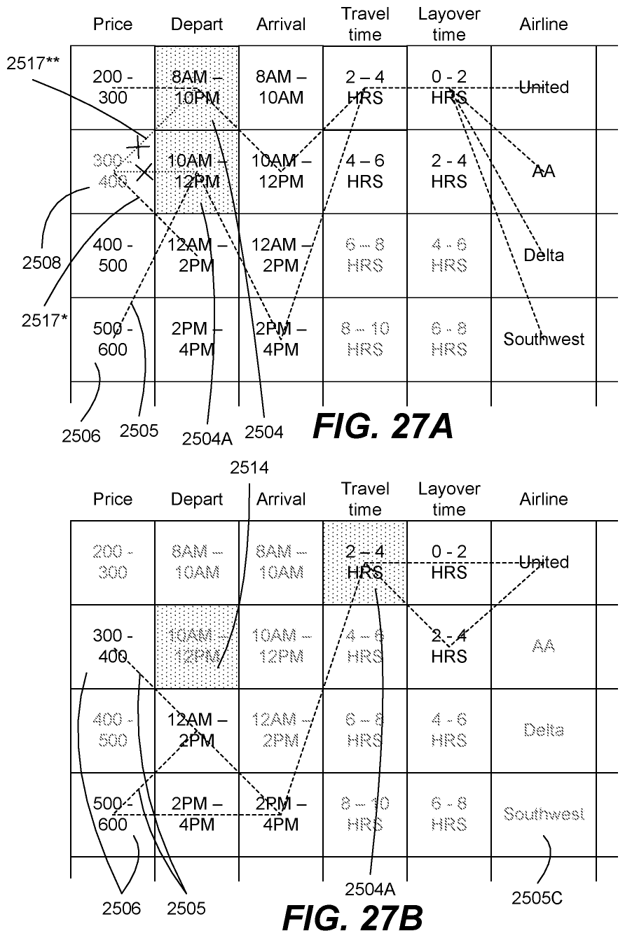

FIGS. 27A-27B illustrate OR and AND selection processes for a flight matrix according to some embodiments. A first selection, followed by another selection, such as another positive selection, can be performed on a flight matrix. The second selection can be an OR or an AND logical operation between the first and second selections.

As an example, after a first positive selection, e.g., after a selection of a first element with marking designated the selected first element as a positive selected element, the flight matrix can be marked or updated based on the selected positive first element, e.g., the elements of the flight matrix can be marked as whether or not having a flight satisfying the selected first positive element, as discussed above.

A second positive element can be selected. The selected second positive element can be automatically chosen or by manually chosen such as by a positive selection from a pop up menu as discussed above. For example, the selected second element can be marked as a cancellation element, a supersede element, or a combinable element (e.g., AND or OR) with the first positive selection.

If the selected second element is marked as a logical AND or OR, then elements of the flight matrix are marked as whether or not having a flight satisfying the selected first and second elements. For example, the first selection can be a positive selection of Southwest airline.

The second selection can be a positive selection of United airline, with a logical OR combination. An element of the flight matrix is marked as having a flight if there is either a Southwest or a United flight meeting the information of the matrix element. For example, an element of 10-12 departure time of the flight matrix is marked as having a flight if there is either a Southwest or a United flight that departs at 10-12. An element of the flight matrix, such as a 300-400 cost, is marked as not having a flight if there is no Southwest or United flight that costs 300-400.

Alternatively, the second selection can be a positive selection of 10-12 departure time, with a logical AND combination. An element of the flight matrix, such as a 0-2 hr layover time, is marked as having a flight if there is a Southwest flight departing at 10-12 having a layover time of less than 2 hours. An element of the flight matrix, such as a 300-400 cost, is marked as not having a flight if there is no Southwest flight departing at 10-12 that costs 300-400.

Alternatively, the second selection can be a negative selection of 10-12 departure time, with a logical AND combination. An element of the flight matrix, such as a 0-2 hr layover time, is marked as having a flight if there is a Southwest flight having a layover time of less than 2 hours that does not depart at 10-12. An element of the flight matrix, such as a 300-400 cost, is marked as not having a flight if there is no Southwest flight not departing at 10-12 that costs 300-400.

FIG. 27A shows an OR selection of two positive selections on the flight matrix. The element 2404 can be first selected, and the matrix sorted according to the selection. Then an OR selection 2404A can be performed. The matrix can be re-sorted according to the combination of the two selections. The selections can be OR, meaning, flights meeting either selection can be selected and flights not meeting both selections can be removed. Thus new flights in the matrix can marked as having flights. For example, with the additional selection of 10-12 departure time, there can be flights with the price range of 500-600, and the element 2406 can be selected as containing flights meeting the selection characteristics. There can be no flight 2517** with the price range 300-400, and the element 2408 can be grayed out. There can be flight having price range of 300-400, such as flight 2517* departing at 12-2, but there is no flights 2517** departing at 8-10 and at 10-12.

The first selection can be a negative selection, with the second selection being a cancellation of the first negative selection, a supersede of the first negative selection, an AND or an OR logical operation between the first negative selection and the second selection.

After the first negative selection, e.g., after a deselection of a first element, the flight matrix can be marked or updated based on the selected first element, e.g., the elements of the flight matrix can be marked as whether or not having a flight satisfying the selected first negative element, as discussed above.

A second element can be selected. The selected second element can be automatically marked or manually marked. For example, the selected second element can be marked as a cancellation element, a supersede element, or a combinable element (e.g., AND or OR) with the first negative selection.

If the selected second element is marked as a logical AND or OR, then elements of the flight matrix are marked as whether or not having a flight satisfying the selected first and second elements. For example, the first selection can be a negative selection of Southwest airline.

The second selection can be a positive selection of 10-12 departure time, with a logical AND combination. An element of the flight matrix, such as a 0-2 hr layover time, is marked as having a flight if there is a non-Southwest flight departing at 10-12 having a layover time of less than 2 hours. An element of the flight matrix, such as a 300-400 cost, is marked as not having a flight if there is no non-Southwest flight departing at 10-12 that costs 300-400.

Alternatively, the second selection can be a negative selection of 10-12 departure time, with a logical AND combination. An element of the flight matrix, such as a 0-2 hr layover time, is marked as having a flight if there is a non-Southwest flight having a layover time of less than 2 hours that does not depart at 10-12. An element of the flight matrix, such as a 300-400 cost, is marked as not having a flight if there is no non-Southwest flight not departing at 10-12 that costs 300-400.

FIG. 27B shows an AND selection of a negative selection and a positive selection on the flight matrix. The element 2414 can be first deselected, e.g., selected to be a negative selection, and the matrix sorted according to the selection. Then an AND selection 2404A can be performed. The matrix can be re-sorted according to the combination of the two selections. The selections can be AND, meaning, flights meeting both selections can be marked and flights not meeting at least one selection can be removed. Thus new flights in the matrix can marked as having flights.

For example, the first selection 2514 can be a negative selection of flights departing at 10-12. A subsequent positive selection of a total travel time of 0-2 hrs can be selected. There can be flights 2505 with the price range of 300-400 and 500-600 that do not depart at 10-12 and that have a total flight time of 0-2 hrs. Thus, elements 2406 can be selected as containing flights meeting the selection characteristics. There can be no Southwest flights that do not depart at 10-12, e.g., all Southwest flights depart at 10-12, and the Southwest element 2405C can be grayed out.

In some embodiments, the display of the search results can be re-arranged to show additional flights characteristics. The flight matrix can be expanded to broaden the search results, e.g., to include more information or flight itineraries. For example, a column or row of the matrix can be expanded into two or more columns or rows, with the two or more columns or rows comprising information related to the information of the column or row.

For example, new category can be added to existing categories, such as departure time and departure city can be added to departure, to provide nearby cities or airports. A customer might specify a departure airport. The search can include nearby airports, as to provide the customer a wider selection of possible flight itineraries.

New data or data ranges can be added to rows, such as expanding an element of 8 am-10 am into two elements of 8 am-9 am and 9 am-10 am. The customer might specify a departure date. The search can include days before and days after the specified date, such as a few weeks, e.g., 1, 2, 3 or 4 weeks before or after, or a few months, such as 1, 2, 3 or 4 months before or after, as to provide the customer a wider selection of possible flight itineraries.

The flight matrix can be contracted to simplify the display, e.g., combining more information in elements of the flight matrix. For example, multiple columns or rows of the matrix can be consolidated or contracted into one column or row, with the one column or row comprising data of the multiple columns or rows. For example, existing categories can be consolidated into fewer categories, such as departure time and departure city can be consolidated into departure, or departure city can be omitted. Data or data ranges can be consolidated into fewer rows, such as two elements of 8 am-9 am and 9 am-10 am can be consolidated into one element of 8 am-10 am. Alternatively, a date range of the category departure date can be 1 hour, 2 hours, 10 hours, 1 day, 2 days, or 1 week.

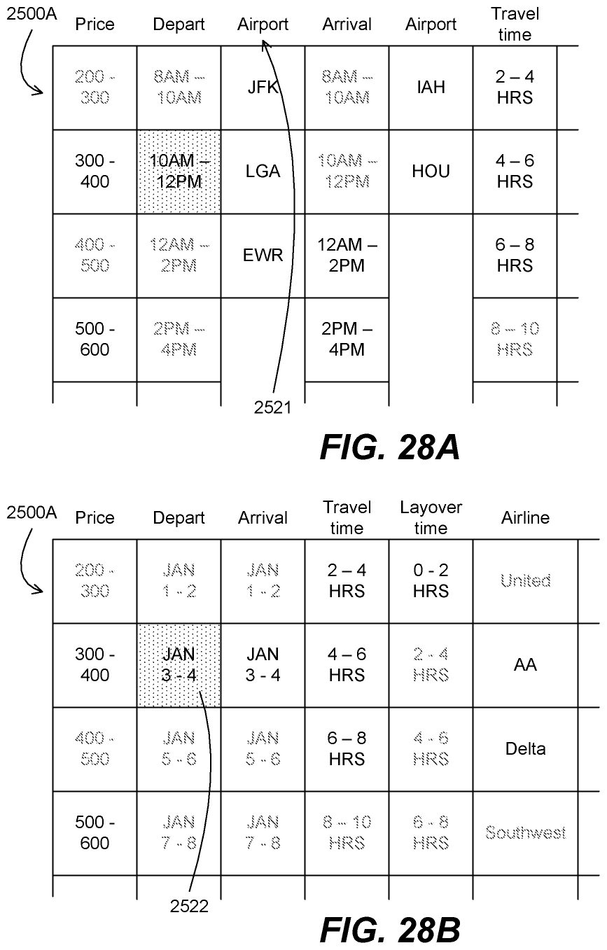

FIGS. 28A-28B illustrate expanded and contracted flight matrices according to some embodiments. In FIG. 28A, the flight matrix 2500A can be expanded to include a category of airport 2521, which can include the nearby airports corresponded to an input airport from the customer. For example, the customer can specify New York City, and the search can include the airports in and near New York City, which includes JFK, LGA and EWR.

In FIG. 28B, the flight matrix 2500A can be contracted so that the date range of the departure time can be 2 days, thus at least an element 2522 can be 2 days. As shown, other elements of the departure date category can be 2 days, but other configurations can be used, such as different date ranges for different elements of the departure time column.

In some embodiments, the display of the search results can be re-arranged to show suitable flight itineraries.

The flight matrix can show the list of available characteristics of flight itineraries, without actually showing the flight itineraries. For example, the flight matrix can show that there are flights cost between 200 and 300, and there are flights from United. However, there might not be a United flight that costs 200-300. The re-arrangement of the flight matrix can show the flight itineraries.

The flight matrix can be re-arranged, to switch between showing the list of available flight characteristics and the flight itineraries. The re-arrangement can be performed any time, for example, after a filtering process, e.g., removing elements of the flight matrix according to the customer selections. The re-arrangement of the flight matrix can be performed without updating the search results, since the re-arrangement can simply re-arrange the same data for display purposes.

The re-arrangement can include connecting lines, e.g., adding connections between elements of the matrix, for showing the information of individual flight itineraries. The re-arrangement can include re-arranging the flight matrix into multiple rows, with each row containing information of a flight itinerary.

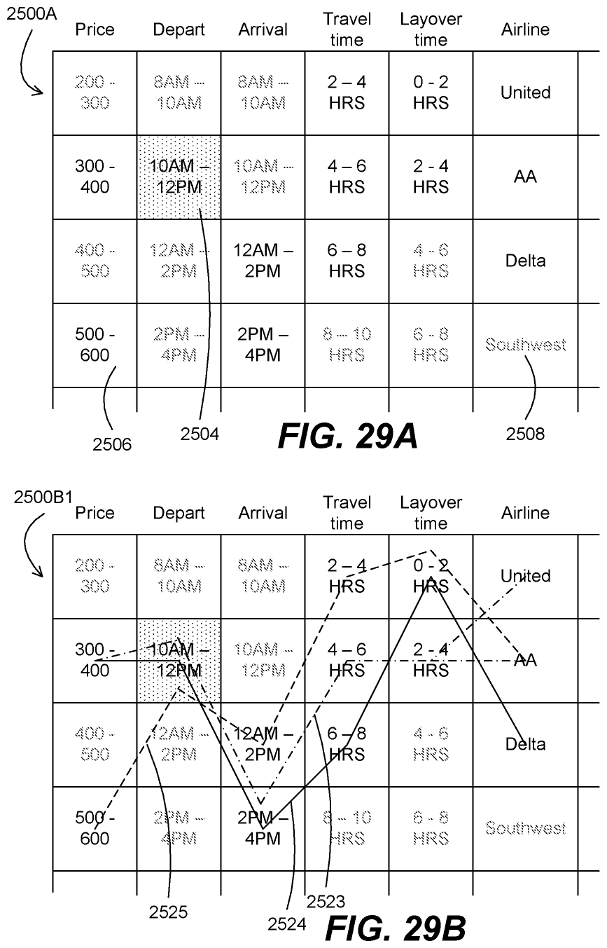

FIGS. 29A-29B illustrate a re-arrangement of flight matrices according to some embodiments. Connecting lines can be added to show individual flight itineraries. The search results of a travel plan can be displayed in a flight matrix, for example, a matrix using categories in columns and data of categories in rows. For example, a flight matrix 2500A can be displayed, optionally with element 2504 (flight departing between 10 and 12) selected as a flight criterion. For the selection of departure time between 10 and 12, the elements of the matrix can be marked, such as elements 2506 marked as having flight and elements 2508 marked as not having flights. The marking of the elements can be performed after one or more selections of flight characteristics, as described above. As shown, the flight matrix 2500A lists characteristics of possible flight itineraries, such as element 2506 showing that there is at least a flight itinerary that cost between 500 and 600. Or that element 2508 shows that there is no Southwest flight for the input travel plan.

The flight matrix 2500A can be re-arranged into flight itinerary 2500B1, which can show the flight itineraries. For example, connecting lines 2523, 2524, and 2525 in the flight matrix can be included to show the individual flight itineraries. Three flight itineraries can be shown for this flight matrix arrangement. For example, there is a flight itinerary 2525, which costs between 500 and 600, which departs between 10 and 12, arrives between 12 and 2, for 2-4 hour travel time with 0-2 layover time, and is operated by American Airlines. There are two other flight itineraries 2523 and 2524, with flight itinerary 2523 operated by a combination of United and American Airlines and flight itinerary 2524 operated by Delta, which have some similar flight characteristics such as cost and departure time, but having different travel times.

The re-arrangement of the flight matrix, e.g., toggling between listing of information (as shown in flight matrix format 2500A) and flight itineraries (as shown in flight itinerary format 2500B1), can be performed without updating of the search results. All data have been stored in the saved search results, so the toggling or re-arrangement of the flight matrix can be quickly completed. Thus the customer can perform selections of suitable flight itineraries without or with minimum waiting time, since the operation can be completed using saved search results.

In some embodiments, the search results can be periodically updated, for example, after every 5 minutes, 10 minutes, 15 minutes, 20 minutes, etc. The periodic update can ensure that the flight matrix contains up-to-date information, such as reflecting changes due to other customers accessing same flight database during the time the customer looks for suitable flight, especially for high demand flights. The update of flight information can be performed in a background.

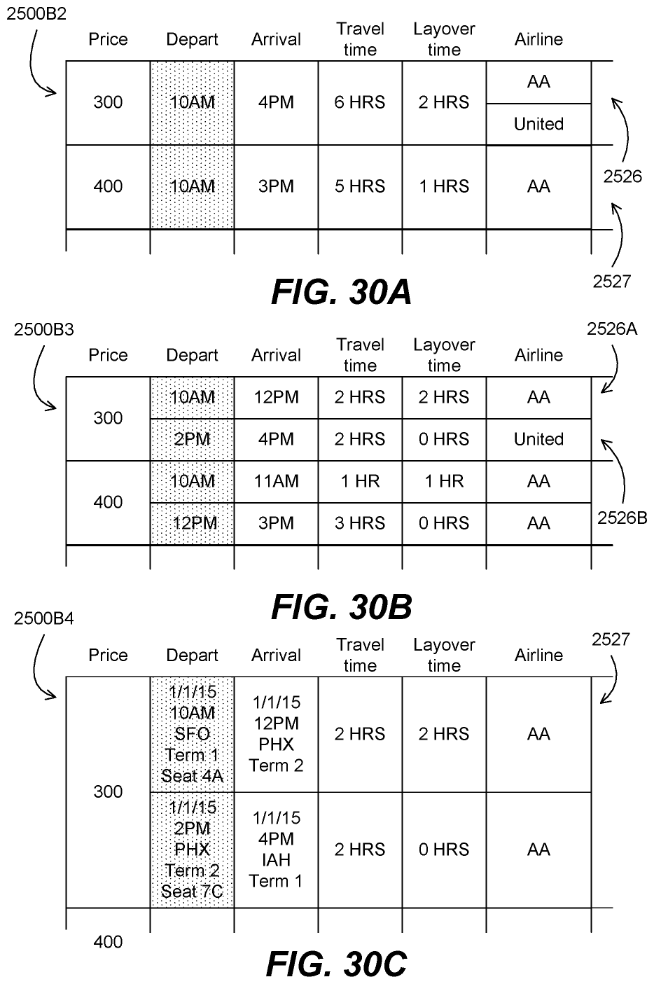

FIGS. 30A-30C illustrate a re-arrangement of flight matrices according to some embodiments. The flight matrix can be re-ordered into multiple rows, with each row containing information of a flight itinerary.

FIG. 30A shows a flight matrix 2500B2, which can be a simple re-arrangement of the flight matrix 2500A above. The flight matrix 2500B2 can include multiple rows 2526 and 2527. Each row can represent a flight itinerary. For example, row 2526 can show a flight itinerary that departs at 10 am, arrives at 4 pm, with 6 hours total travel time and 2 hours layover time. The cost of the flight is 300. The flight itinerary is operated by American Airlines and United. This flight itinerary can be similar to the flight itinerary 2423, shown by connecting lines in flight matrix 2500B1, except with more detail information.

For example, the connecting lines 2423 connect the cost element of 300-400, to the departure time of 10-12, to the arrival time of 2-4, to the travel time of 4-6, to the layover time of 2-4, to the airline of United/American Airlines. In contrast, the flight itinerary 2526 can list the exact value, such as the cost of 300, the departure time of 10, the arrival time of 4, the travel time of 6, the layover time of 2, and the airline of American Airlines and United.

Row 2527 can show a flight itinerary that departs at 10 am, arrives at 3 pm, with 5 hours total travel time and 1 hour layover time. The cost of the flight is 400. The flight itinerary is operated by American Airlines. This flight itinerary can be similar to the flight itinerary 2525, shown by connecting lines in flight matrix 2500B1, except with more detail information.

FIG. 30B shows a flight matrix 2500B3, which can be another re-arrangement of the flight matrix 2500A, and which can show more detail information. Two sub-rows 2526A and 2526B can be used to describe the flight itinerary 2526. Since the flight itinerary can have multiple flight segments, sub-rows can be used to provide detail information. For example, in sub-row 2526A, a first flight segment from American Airlines can depart at 10, arrive at 12 for 2 hour travel time. After a layover time of 2 hours, sub-row 2526B show a second flight segment from United, which departs at 2, arrives at 4 for 2 hours of travel time. The total price for the two flight segments is the same, which is 300.

FIG. 30C shows a flight matrix 2500B4, which can be another re-arrangement of the flight matrix 2500A, and which can show more detail information. Additional information can be included, such as date, airport, terminal, and seat.

In some embodiments, the different flight matrices, e.g., flight matrix 2500A, 2500B, 2500B1, 2500B2, 2500B3, and 250B4 can be toggled, e.g., switching from each other, to allow the customer different views of the possible flight itineraries.

As shown, the flight itineraries are sorted based on price. The flight itineraries can be sorted based on different criterion, such as based on a customer preference.

In some embodiments, the personal travel agency service can display the search results of an inputted travel plan according to a saved customer preference, e.g., sorting the search results according to the customer preference. Thus the most suitable flight itineraries, e.g., the flight itineraries that meet most of the customer preference, can be displayed first, together with the most concerned features showing on the screen. Other flight itineraries and/or other features can be seen by scrolling the screen.

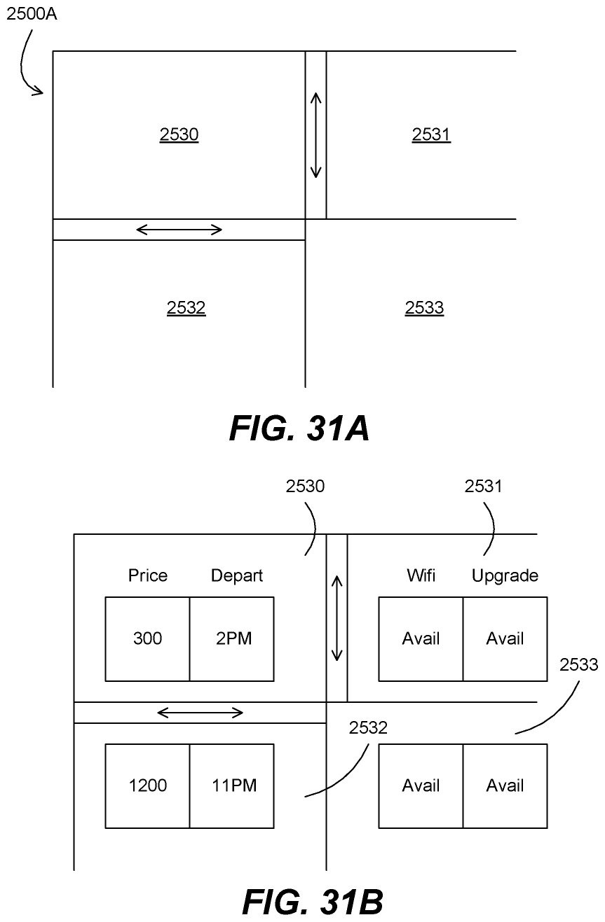

FIGS. 31A-31B illustrate flight matrices to be displayed on a screen according to some embodiments. A flight matrix 2500A, which can contain the search results for a customer travel plan, can be displayed on a screen. The size of the flight matrix 2500A can be larger than the size of the screen, for example, there can be hundreds of flight itineraries, and a large number of flight categories. Thus only a portion of the flight matrix can be seen on the screen. The rest of the flight matrix can be viewed by scrolling the display. For example, the top left portion 2530 can be shown on the screen. The right portion 2531 can be viewed when scrolling the screen to the right. The bottom portion 2532 can be viewed by scrolling down the screen. The right bottom portion 2533 can be viewed by scrolling down and to the right.

The platform can be configured to display the most suitable flight itineraries in the visible screen portion. The most suitable flight itineraries are based on the individual customers, e.g., different customers can have different suitable flights. In other words, a most suitable flight itinerary for a first customer is not necessarily suitable for a second customer. The suitability of the flight itineraries can be based on a customer preference, with the preference updated based on the actions of the customer in selecting flight itineraries.

The suitable flight itineraries can be arranged so that the most suitable flight itineraries are shown first, e.g., in the visible screen. The most unsuitable flight itineraries can be shown last, e.g., in the scroll-down portion 2533 of the screen. For example, if price is very important to a customer, then cheaper flights are shown first, and more expensive flights last. If the total travel time, or the layover time, e.g., the time waiting between flight segments, is important, e.g., a customer might accept up to 4 hours in layover time, then flights with less than 4 hour layover time are shown first, and flights with the most layover time are shown last.

Further the categories of the flight itineraries can be arranged so that the important features of the flight itineraries are shown on the left portion, e.g., on the visible screen. The less important features can be shown on the scroll-right portion 2531. For example, the features of price, departure and arrival information, travel time and layover time, and airline names can be important, which can be shown in the visible screen 2530. The availability of amenities, such as Wi-Fi, upgradable, early boarding, lounge access, etc., can be less important, which can be viewed in the scroll-right screen 2531. Any amenity features that are considered to be important to a particular customer, such as based on a saved customer preference, can be re-arranged to be on the visible screen.

In some embodiments, the present invention discloses methods, systems, and programs that can perform the methods, to authenticate a transaction from a customer through the customer interaction with a display showing search results for a product or service, such as getting suitable flight itineraries to a customer. The programs can form a platform, which runs on a data processing system, such as a computer or a mobile device like a cell phone.

The authentication process can include forming a behavior profile for a customer. The behavior profile can include data from communication sessions of the customer with the platform, past actions and characteristics of the actions of the customer when the customer selects the product or service, and then associating the communication data, the actions and the action characteristics with indications of behavior of the customer.

The travel preference profile can be used for authenticating the customer, such as to authenticate the customer identity, e.g., to ensure that the customer is the person or entity that the customer claims to be. The authentication process is based on a matching of the customer current data with the behavior of the customer stored in the profile. For example, an AI algorithm can compare the data inferred from the customer in communicating with the platform, including the current IP address, the location, the time, the device used by the customer, together with actions of the customer in selecting the product. with the pattern of the customer behavior generated from the profile, e.g., from the past data of the customer in using the platform.

The comparison can determine whether or not the customer is authentic by verifying that the current customer actions are consistent or deviated from the usual customer behavior. In case of an uncertainty, additional authentication step can also be requested from the customer.

In some embodiments, an initial profile can be formed, for example, by collecting data and information from the customer, such as by asking the customer to fill in a questionnaire. The questionnaire can be directly related to the preferences of the customer, which can provide indications of the customer behavior. For example, the customer can specify that low fare is highly desirable, which can translate to a preference of low fares.

The questionnaire can be indirectly related to the behavior preferences. For example, the customer can specify memberships in frequent flyer programs. This information can imply that the airlines with the frequent flyer programs should be of higher preference. If there is more than one frequent flyer program, then the program with the most mileages in it can be more preferred. The frequent flyer data can provide indications of the customer behavior. If all other characteristics being similar, a fraudulent flag can be raised if the customer selects a flight from an airline that the customer has not enrolled in its frequent flyer program.

Data for the profile can be collected from public or private databases, such as credit history, professional association, or correspondence of the customers. For example, the income level of a customer can be determined by the customer answering the questionnaire, or by knowing the profession of the customer through a public database. Thus a low income customer can imply that comforts, such as not excessive layover times between flight segments, additional legroom, or better customer service, can be less preferred than low prices. Thus, a fraudulent flag can be raised if the customer selects an expensive flight while there are lower price flights that are less convenient.

The preferences in the travel preference profile can be relative or conditional, e.g., not always absolute. For example, a preference of low fares can be rated or having a scale factor, e.g., from 0 to 10 with 0 being no preference at all and 10 being an absolute preference. A zero preference of low fares means that money is not a concern in planning the travel itinerary. A preference of low fares means that the customer would do anything in order to have the lowest fare possible. In this case, the travel fare is the first choice, and only different flight itineraries with a same lowest fare are being considered. The AI algorithm can consider all the available data to determine if the current data meets the customer behavior pattern specified by the profile.

In general, most customers have a gray level of preference instead of the extreme values of black and while. When a customer specify a preference of low fares, it typically means a relative preference, e.g., a low fare is preferred if the flight itinerary is not too uncomfortable or too inconvenient. Thus the customer can specify a preference level for low fares, but the specified level can be vague and not accurate, since there can be many factors of comfort and convenience that can affect the low fare decision.

In some embodiments, the preference level can be determined from past actions of the customer, e.g., the actions of the customer in selecting flight itineraries in the past, since the actions of the customer present a clear indication of the meaning of the preference, e.g., the importance of the preference with respect to other aspects of travel. For example, even though the customer might indicate a preference for low fares, the customer might still select a flight itinerary with higher fares. The selected flight itinerary can show the level of the low fare preference, such as selecting a higher fare flight since the low fare flight contains a long layover time between the flight segments. Thus the actions of the customer can be a more reliable indication of the customer travel preferences. The AI algorithm can consider all factors related to the customer behavior, to provide a pattern that can be used for matching with the current actions.

The profile can contain previous actions of the customer during the previous product selections, such as selecting or deselecting features or characteristics, as discussed above, on the matrix format or on the listing format. The customer preference can be updated with the selections made by the customer on the displayed flight itineraries, together with indications of the customer behavior generated from the actions. For example, if the customer chooses morning flights, then morning flights can be added to the preference list. If the customer wants to avoid red-eye flights, then the preference list can include a low preference for red-eye flights.

The actions and characteristics of the actions can indicate a thinking of the customer, e.g., a desire, a preference, or a behavior of the customer. For example, if the customer selects a particular airline, this can indicate a strong preference of the customer toward the selected airline. If the customer selects short layover times between flight segments or stops, this can indicate a preference of comfort and convenience, e.g., over low fares.

The customer selections can be related to different aspects of the flights, such as early boarding option, Wi-Fi, better meal services, safety record of the airline, on time performance of the airline. The selections can indicate a preference of the customer with respect to the airline service. The actions of the customer can also indicate the level of the preference, for example, by the additional fare that the customer is willing to pay for such services.

The customer can browse for flights, e.g., searching but not booking or buying. The preferences associated with the browsing actions can have a lower weight in the travel preference profile, such as comparing to actions resulted in flight booking.

In some embodiments, the characteristics of the actions can include a delay time between two consecutive actions. For example, if there is a very short time between two actions, with the second action supersedes the first action, then there could be an error in the selection process, and any preference associated with the first action might not be valid. If there is a long time delay before a second selection, then the customer might be hesitated, e.g., not sure about the second selection, and thus the second selection can carry less weight as compared to other selections.

The profile can contain the information that the customer provides to the platform, either directly or inferred by the platform. For example, the information can include data from a questionnaire filled by the customer. The information can include name, birthday, traveling preferences, membership in frequent flyer programs, and income. Other information can also be collected, since the information can be used to make decision in fraudulent detection. The use of the information can be explicit. For example, a customer can specify that low fare is the highest priority. Thus flight itinerary selection can be simplified with fares being the top priority. The use of the information can be implicit. For example, a high income customer would be likely to select comforts over prices, and thus higher fare plan for short layover time (e.g., waiting time between segments of the travel plans) or additional legroom or better customer service can be preferred over lower fare plans.

In some embodiments, the information can be collected from public or private databases, such as credit history and professional association of the customers. The information can be collected from the customer activities, such as from correspondence of the customers, which can indicate a traveling preference of the customers. For example, the customers can send emails, discussing traveling, and indicating that early check-in or boarding can be an important consideration in air traveling. This information can be used to provide indications of the customer behavior, such as a preference to comfort for early checking or boarding.

The profile can contain the communication information from the customer when contacting the service provider, such as the devices used by the customer, the IP addresses, the login times and locations, and mouse and keyboard usage of the customer. The access to the communication information used by the customer can provide indications of the customer behavior, such as a long delay time before a high price selection can indicate a reluctance of the customer for high price products, multiple login times during after business hour can indicate a customer having a normal working schedule, or consistent IP addresses and login locations can indicate a less traveled customer.

In some embodiments, the profiles can be updated, e.g., the programs can ask the customers for additional data, e.g., beyond the stored data and information that the customers have supplied, to provide a complete behavior profile. For example, in cases in which the current actions are ambiguous, e.g., not clearly distinct or clearly matched the profile pattern, the programs can ask the customer for addition information to determine the customer authentication. The programs can provide simulated flight booking for additional information in behavior. A customer can browse through the flight itineraries, with all actions similar to a real flight booking. The actions and characteristics of the actions of the customer during the simulated booking can provide the additional information needed by the AI algorithm during the determination of whether or not there is a deviation from the current actions to the profile behavior pattern.

For example, the programs can have a machine-learning module, which can learn from past actions of the customers, such as the selection of travel plans that the programs present to the customers. The programs can provide travel plans with different characteristics, such as one having low fare/low comfort and one having high fare/high comfort. Based on the selection of the customers, a preference matrix can be established, formulating a preference relationship between price and comfort.

In some embodiments, the customer preference can be updated through the customer selections on the flight matrix. For example, if the customer selects United to be a selected element, e.g., a positive selection, in the display flight matrix, then the item “United airlines” can accumulate an additional priority point. In contrast, if the customer selects American Airlines to be a non-selected element, e.g., a negative selection, in the display flight matrix, then the item “American Airlines” can have a priority point subtracted. In some embodiments, if the customer selects a final itinerary for purchase, then the features of the flight matrix shown in the visible display can each be added a priority point, implying that the display matrix represents a customer preference. The customer preference can be generated, or assisted in the generation, through artificial intelligence and machine learning.

In some embodiments, the information can be collected from past actions of the customers. For example, even though the customers specify a preference of comforts over prices, the customers still select flight itineraries having lower fare and slightly high discomforts. Thus the past actions of the customers can be a more reliable indication of the customer travel preference, for example, over the answered questionnaires.

In some embodiments, associating action characteristics with customer behavior can include linking the action characteristics with the behavior of the customer. Indications of the customer behavior can be generated from the data received or inferred from the customer, to form a pattern of the customer behavior, which can assist the AT algorithm is authenticate the customer.

In some embodiments, the customer behavior can be multiple modals instead of single modal, e.g., the customer can exhibit different behavior patterns depending on different situations. For example, the customer can have a first behavior pattern when traveling on personal expenses and a second behavior pattern when traveling on business expenses. For example, convenience can have a higher priority than prices for business traveling. In addition, traveling with family, especially with young children can have different preferences than traveling alone. Thus the customer behavior pattern can be classified into different modes, such as business mode for business traveling, personal mode for leisure traveling, and family mode for traveling with family, either for business or pleasure.

In some embodiments, the methods can include machine intelligence, which can contain an AI algorithm to authenticate the customers from the actions and communication of the customers with the platform. The algorithm can be based on the customer travel profiles, such as preference profiles and behavioral profiles. Different preference travel profiles can be used, such as traveling for business (e.g., business profile) or pleasure (personal profile), with or without family members (single or family profile). For example, the methods can detect anomaly in actions and communication of the customers, which can increase an estimate for fraudulent risk of the customer activities, when the current actions and communication of the customers are not consistent with the customer profiles. The profiles for multiple customers can be stored in a database, and can be updated with the customer data, including the current actions and communication of the customers.

In some embodiments, the present invention discloses programs that can perform the machine intelligence methods for selecting flight itineraries for the customers. The programs can be used in a data processing system, or can be used in a mobile system, such as a cell phone, which can communicate with airlines for generating travel plans, and which can perform the machine intelligence algorithms for choosing flight itineraries for the customers. The programs can communicate with the customers through voice and/or display. For example, a customer can dictate (or type) to the programs to find a travel plan on a certain date to a certain city. The programs can respond by display and/or speech to tell the customer the available travel options.

In some embodiments, the present invention discloses behavioral profiles for customer travels. The profiles can be dynamically developed, e.g., the profiles can be updated with the customer behavior and actions. For example, an initial profile can be provided, using inputs from the customer. The initial profiles can include information similar to that given to a human travel agent. For example, the initial profiles can include a preference of the customer regarding seat selection, e.g., aisle or window seat.

The profiles can be dynamically enhanced, for example, with data input from the client's purchase history and behavior in making choices from the travel offerings that are presented to him/her. The profiles can also be dynamically enhanced with data collected on the client from social media and the World Wide Web. The dynamic enhancement can help refine the behavioral predictability and help the programs making decisions that mirror the client's own behavior.

In some embodiments, the profiles or the preference matrix can include multiple elements, each with different important scale. For example, the profiles can include price, which can be a less important factor when travelling for business as compared to travelling for leisure. The profiles can include schedule convenience, which can be firmer for business travel versus more flexibility for leisure travel. The schedule convenience can include departure time, arrival time, number of flight segments, e.g., number of stops, and layover time between flight segments. The profiles can include other elements, such as maximum number of stops, connections, or flight segments, optimal layover time between flight segments, free checked bags, priority boarding, complimentary upgrades, system wide upgrades, better customer service/dedicated phone lines, discounted/free lounge access, mileage earning bonuses, access to preferred seating ahead of time, waived award fees for tickets, free same-day changes, free or discount on ticket change fees, price hold on booking for a period of time, free/discounted refund or exchange fees, free Wi-Fi, free meals, extra leg room, free entertainment (movies, games etc.).

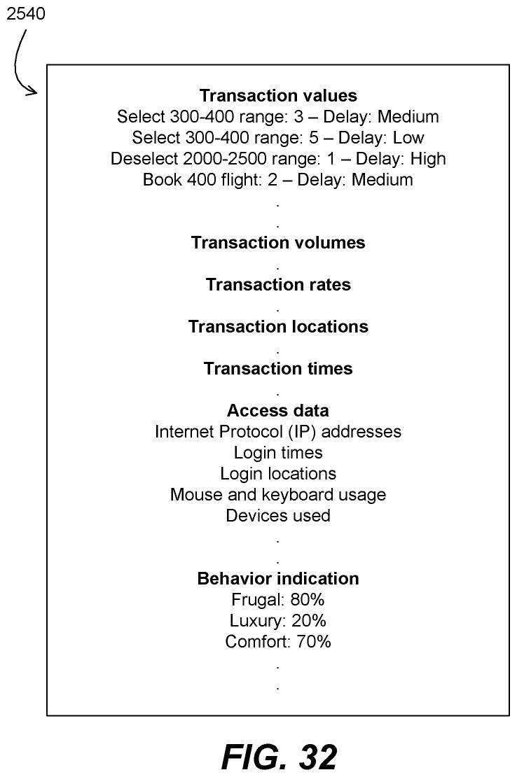

FIG. 32 illustrates a configuration of a behavior profile according to some embodiments. The profile can have a number of elements. Each element of the profiles can have a scaling factor, which indicates the importance of the element for a particular trip. For example, a customer can place high importance to price, thus the price element can have a scaling factor of, for example, 7 out of 10. The customer can travel alone with minimum baggage, thus can place low importance to pre-boarding access or priority boarding, thus the pre-boarding element can have scaling factor of, for example, 2 out of 10. The scaling factor can be a function, instead of a number. For example, a layover time of 2 hours can be considered optimal, and can have a scaling factor of 8. A layover time of 6 or more hours can be considered undesirable, and thus can have a scaling factor of 1. The profiles can be used to rank the different available travel plans, and the travel plans having high ranks can be selected for the customer review, or for purchasing the flight. The scaling factor can be a function of airlines, e.g., the customer can have different preferences for different airlines. For example, a customer may not want American Airlines to offer a lounge at the airport because the customer already has a yearly lounge pass with American Airlines. A customer may or may not want United Airlines to offer a lounge at the airport because the customer already has a yearly lounge pass with American Airlines. For example, if the United Airlines lounge is closer to a departing gate as compared to the American Airlines lounge, the customer might be interested in obtaining the United Airlines lounge pass.

The profile can include actions of the customer, together with the transaction values. For example, the profile can include a number of customer selections for different price ranges, together with values for the delay between consecutive actions. The profile can also include transaction volumes, which provide the number of transactions the customer, transaction rates, which provide the rate of transactions the customer, transaction locations, which provide the locations of the transactions, such as the locations of the customer or the location of the departure or arrival of a flight itinerary of the customer, transaction times, which provide the times and dates of the transactions.

The profile can include access data, which includes the communication information between the customer and the platform. For example, the access data can include the Internet Protocol (IP) addresses that the customer uses when contacting the platform, the login times and locations of the customer, and the devices used by the customer. In addition, the access data can include the emotional state of the customer during the communication sessions, such as the mouse and keyboard usage.

The profile can include indications of the behavior of the customer, such as indications of the customer lifestyle, such as a high frugality, low luxury, and high comfort and convenience.

### Method to Assessing a Fraudulent Risk

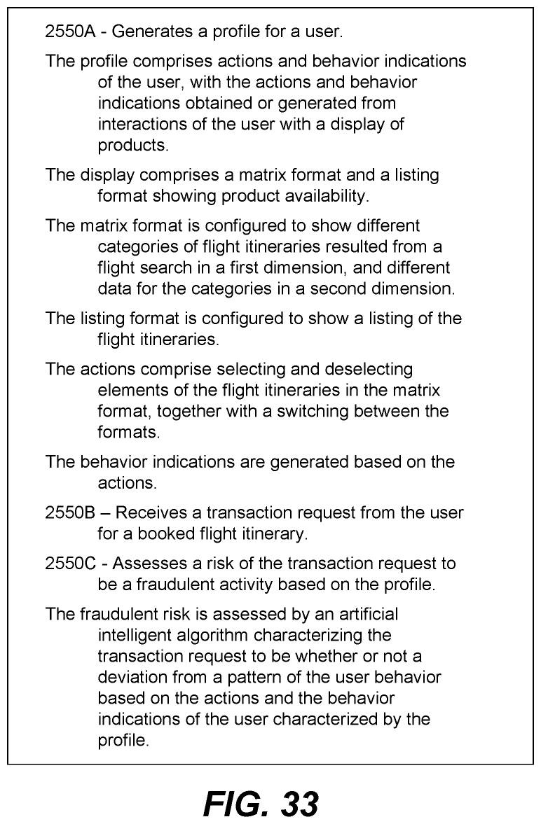

FIG. 33 illustrates a flow chart for authenticating a user according to some embodiments. Operation 2550A generates a profile for a user. The profile comprises actions and behavior indications of the user, with the actions and behavior indications obtained or generated from interactions of the user with a display of products.

The display comprises a matrix format and a listing format showing product availability. The matrix format is configured to show different categories of flight itineraries resulted from a flight search in a first dimension, and different data for the categories in a second dimension. The listing format is configured to show a listing of the flight itineraries.

The actions comprise selecting and deselecting elements of the flight itineraries in the matrix format, together with a switching between the formats. The behavior indications are generated based on the actions.

Operation 2550B receives a transaction request from the user for a booked flight itinerary.

Operation 2550C assesses a risk of the transaction request to be a fraudulent activity based on the profile. The fraudulent risk is assessed by an artificial intelligent algorithm characterizing the transaction request to be whether or not a deviation from a pattern of the user behavior based on the actions and the behavior indications of the user characterized by the profile.

In some embodiments, the present invention discloses a computer-implemented method to form a profile for a user, which can be used to authenticate the user through an AI algorithm comparing a current action or a current communication session to a behavior pattern of the user generated based on the profile. The method includes (1) forming or updating, by a platform, a profile of a user, or a database having the profile of the user, for assessing an estimate of a fraudulent risk; (2) receiving a flight search request from the user; (3) displaying a flight search result, with the flight search result comprising multiple flight itineraries resulted from the flight search request; (4) receiving a user input comprising a second action of the user comprising a selection or a deselection of a flight element in the flight matrix format or a flight itinerary in the flight itinerary format; (5) updating the display of the flight search result after the user input, with the selection of the flight element removing flight itineraries not meeting the selected flight element, and with the deselection of the flight element removing flight itineraries meeting the deselected flight element; (6) generating an indication of a behavior of the user based on at least the first and second actions; (7) updating the profile of the user in the database with the first and second actions and the user behavior indication; (8) receiving a request from the user for a transaction involving a flight itinerary booked by the user to a supplier providing the booked flight itinerary; (9) assessing a risk of the transaction being fraudulent using the profile to provide an estimate of the fraudulent risk associated with the user; (10) accepting the transaction when the fraudulent risk estimate is below an acceptable value; (11) sending the request to the supplier.

The method can further include updating the profile with information about the transaction and the acceptance of the fraudulent risk of the user, e.g., the profile is updated with the information from the current transaction, and the acceptance that the fraudulent risk is low.

The profile can include a log of actions in transactions associated with the user, together with information on the communication session between the user and the platform, and together with indications of user behaviors based on the user actions. The profile can be stored in a database, together with the profiles of other users.

The transaction actions can be obtained during a process of the user selecting a flight itinerary among multiple flight itineraries, which are the result of a flight search presented to the user based on a flight search request from the user to the platform. The profile further can include information related to the user and collected by the platform, such as data supplied to the platform by the user during the communication session, or data inferred by the platform from the communication. For example, the user can sign up to the platform services, and then answer a questionnaire having a password, a PIN number, secret questions, or a numerical sequence, an email address or billing address, possession comprising at least one of a mobile phone, wearable devices, a token, or a smartcard, inherent feature comprising at least one of fingerprint, voice recognition, iris recognition, or facial features. The profile can contain information obtained indirectly from the user, such as the IP addresses or the communication equipment or devices that the user uses when contacting the platform, The indirectly-obtained information or data can include the times or the locations that the user uses when contacting the platform, or the habit of the user in using the communication equipment, such as the usage of the keyboard or mouse. The profile can contain information obtained from public or private agencies or institutions, such as from disclosure or correspondence of the user in social media or in email.

The indications of the user behaviors can be generated by the platform based on the information directly or indirectly obtained from the user. For example, the data obtained from the user can be conflict or contradict each other due to differences in user situations that are not known by the platform. Thus, a machine learning program or an AI algorithm cam be used to determine the user behavior based on the user information.

There can be a direct relationship between the obtained information and the customer behavior, such as a low price selection can provide an indication of a frugal nature of the customer, or a localization of the user locations based on the IP addresses can provide an indication of the place of residence of the user.

There can be an indirect relationship between the obtained information and the customer behavior, such as after-business times of contacting the platform can provide an indication of a 9-to-5 employee, or a consistence of contacting the platform during business hours can provide an indication of a self-employed user or a non-working user.

The indications of the user behaviors can be generated by the platform through a statistical analysis of the user information, such as lower price than high price selections can provide a high percentage of the user being frugal, or many long delay times between two consecutive inputs such as selections can provide a high percentage of the user being cautious.

The user information can be obtained directly or indirectly from the actions of the user in selecting a product, such as a flight itinerary, among multiple flight itineraries that the platform presents to the user based on a search request from the user. The indirection information can include status data from the communication session between the user and the platform, such as the IP address, the device or equipment used, the habit of keyboard and mouse usage. The direct information can include the actual selections of the user on a display of the flight search result.

The flight search result can be displayed in a flight matrix format or a flight itinerary format. The flight matrix format can be configured to show multiple flight elements configured in different flight categories in a first dimension and either different ranges or values of the flight categories in a second dimension. In the flight matrix format, there can be one or more elements of the flight matrix that are marked as there can be not a flight itinerary of the search result meeting the flight category and the range or value of the one or more elements.

The matrix format only shows the availability of the ranges or values of the flight categories, without showing the flight itineraries. Elements of the flight matrix can be configured to show that there is not a flight itinerary meeting the flight category and the range or value of the elements. For example, the flight matrix can show that there are Southwest flights, there are flights departing at 8-10, and there are flights costing 300-400. However, the flight matrix does not show that there are Southwest flights departing at 8-10 with the cost of 300-400. In contrast, the flight itinerary format can be configured to show a list of the multiple flight itineraries, but not the individual ranges or values of flight categories.

The actions can include a switching action of the user between the flight matrix format and the flight itinerary format. For example, there can be a command button which can allow the user to change the format, such as a listing button in the matrix format for changing to the listing format, and a matrix button in the listing format for changing to the matrix format.

The actions can include a selection or a deselection of a flight element in the flight matrix format. For example, the user can select Southwest, showing a preference for Southwest, since the user has a frequent flyer with Southwest. The user can deselect United, showing a dislike for United, perhaps since the user has a bad travel experience with United. The selection and deselection can show indications of the user behavior,

The display of the flight search result can be updated with the selection of the one or more flight elements removing flight itineraries not meeting the selected one or more flight elements, and with the deselection of the one or more flight elements removing flight itineraries meeting the selected one or more flight elements.

The actions can include a selection or a deselection of a flight itinerary in the flight itinerary format, for browsing or for booking. For example, the user can select a low cost flight or deselect an expensive flight, which can show a preference for low cost and a dislike for high cost. Thus, the actions of the user can be used to generate a behavior profile for the user, with the user behavior profile including indications of the user behavior.

After each action, e.g., either a selection or a deselection, the display of the flight search result can be updated with flight itineraries not meeting the selected flight element or flight itineraries meeting the deselected flight element removed from the flight matrix format;

The display formats of a matrix and a listing shown are an example of a selection of a product which is a flight itinerary. Other product searches can be displayed, such as a hotel search result, a car rental search result, or other products or services.

The behavior profile can be used to assess an estimate of the fraudulent risk of the transaction requested, such as an authentication of the user identity, to ensure that the transaction request is legitimate. For example, assessing the risk of the transaction being fraudulent can include authenticating an identity of the user. Alternatively or additionally, assessing the risk of the transaction being fraudulent can include assessing an ability of the user with regard to the transaction, such as an employment status, a banking status, a debt status, or any information that can the ability of the user to complete the transaction.

The estimate of the fraudulent risk can be performed by an artificial intelligent algorithm characterizing the transaction request to be whether or not a deviation from a pattern of the user behavior based on the actions and the behavior indications of the user characterized by the profile. If the current actions of the user are consistent with the behavior pattern of the user shown in the profile, the user is authenticated. For example, if the IP address and location of the user is the same or within a local area with the data in the profile, the fraudulent risk is low. Multiple verifications using different actions of the user can be used to further lower the estimate of fraudulent risk.

If the current actions of the user deviate significantly from the behavior pattern, the fraudulent risk can be high. For example, if the user behavior pattern indicates a frugal nature, and the user transaction includes a first class flight, this can indicate a high risk of the transaction being a fraudulent activity. In cases of high risk, for example, the fraudulent risk estimate is higher than a threshold value, the platform can perform additional authentication steps, such as asking for additional verifications.

### Modified Transaction

In some embodiments, the present invention discloses a method for modifying one or more fields of a transaction. The transaction is originated from a sending entity or party to a receiving entity party to provide the receiving entity or party with a value of the transaction. The transaction is routed to an intermediate party, e.g., the intermediate party is configured to receive the transaction, then to forward or send the transaction to the receiving party. The transaction can be considered as passing through the intermediate party, on the path from the sending party to the receiving party.

The modification is configured to provide a pass by value characteristic to the transaction, instead of a pass by reference, from the sending party to the intermediate party. In the pass by reference process, the transaction is passed to the intermediate party, e.g., the transaction is still linked to the sending party, with all issues related to the transaction, either before or after the completion of the transaction, still under a control of the sending party, e.g., the transaction is still related to the sending party, or the sending party is still responsible for the transaction to the receiving party. The pass by reference can be considered as a proxy transfer, which is configured to allow the intermediate party to represent the sending party to deliver the transaction to the receiving party, but the ultimate responsibility still stays with the sending party.

In practice, to implement the pass by reference process, for example, a transaction can include a present field containing a link to or a party responsible for the transaction. The sending party, such as the user, can send a transaction to the intermediate party, such as the platform, with the present field identified the sending party, or the user, as the responsible party. Thus, in the transaction, the present field is linked to the sending party, or to the user, showing that the sending party is responsible for the transaction, e.g., for the value of the transaction. In the pass by reference, the intermediate party forwards or send the transaction to the receiving party, with the present field unchanged, such as the responsible party is still the sending party. The function of the intermediate party is to act as an intermediate, e.g., passing the transaction to the receiving party with the field values still referenced to the sending party. In the pass by reference, the transaction can be sent to the receiving party, by the intermediate party, without changing.

In the pass by value process, the values of the transaction are transferred to the intermediate party, instead of just passing the transaction. The transfer of the transaction includes the transfer of the transaction fields to the intermediate party, such as the present field is supplied to the intermediate party, e.g., the intermediate party obtains the transaction value and the sending party is responsible to the intermediate party for the transaction value. The pass by value is a complete transfer, which is set up as a transaction between the sending party and the intermediate party.

After accepting the transaction, in the pass by value, the intermediate party can change the transaction, and then send the modified transaction to the receiving party. The present field is changed to link to the intermediate party, e.g., the present field is modified to identify the intermediate party as the responsible party. With the change of the present field, the intermediate party now functions as the responsible party for the modified transaction, e.g., the intermediate is now enabled to contact the receiving party to perform any follow up activity. The modified transaction can be configured to allow the intermediate party to take over the after-effects of the transaction, e.g., as an owner of the original transaction when dealing with the receiving party. With the modified transaction, the sending party is no longer linked to the receiving party, and all issues related to the transaction are under a control of the intermediate party, e.g., the intermediate party is now responsible for the transaction to the receiving party.

The modified transaction can be the original transaction with changed fields. Alternatively, the modified transaction can be a new transaction with the transaction fields of the new transaction having the values of the modified transaction. Thus, the intermediate party can either prepare and send a new transaction to the receiving party, or can change the original transaction.

The modification of the transaction, e.g., the change of the transaction fields, can vary the nature and consequence of the transaction, such as to change a responsible party, which can allow the intermediate party to perform followed up activities, instead of simply representing the sending party. For example, the transaction field modification or substitution can provide the intermediate party, such as the platform, an ability to contact the receiving party, such as the supplier, after the completion of a transaction for a sending party, such as a user. The contact ability is configured to completely replace the sending party with the intermediate party, e.g., as if the transaction originates from the intermediate party.

The modification of the transaction can be configured to let the intermediate party taking over the transaction, instead of simply representing the sending party that originates the transaction, e.g., the modification replaces the representation of the sending party by the intermediate party with the intermediate party being a fully responsible party.

Further, the modification of the transaction can preserve as much as possible the field data of the original transaction to avoid potential confusion to the receiving party. The original transaction is from the sending party to the receiving party, with the intermediate party acting as a passing through party. Thus, the modified transaction can be configured to preserve the impression that the modified transaction is designed for the sending party.

For example, the transaction can have an additional “for” field or an additional originate field, which is configured to show who or what the transaction is for or who is the party originating the transaction. In the original transaction, for or originate field contains the sending party, showing that the original transaction is for the sending party or is originated from the sending party. In the modified transaction, for field is unchanged, e.g., value of the for field is the sending party, since the modified transaction is configured to show that the modified transaction is for or originated from the sending party.

Further, the modification of the transaction can be randomized to preserve the random nature of different sending parties. Multiple sending parties can contact the intermediate party for services, with multiple original transactions to be sent to multiple sending parties, respectively. Thus, there is a random characteristic in the multiple original transactions. The intermediate party can perform a randomization on the multiple modified transactions when sending to the multiple receiving parties to preserve the random characteristic resulted from the multiple sending parties.

For example, the transaction can have an additional transaction field, which contains data of the transaction related to aspect or characteristic of the transaction, such as the bank institution, the account number, or any related information. The transaction field can contain information that enables the receiving party to receive compensation for the service or product. Different sending parties can send different transaction field data, and thus a randomization of the modified transaction can simulate the variety of the transaction field, for example, to provide the multiple modified transactions sent by the intermediate party look like they are sent from different sending parties.

Further, the transaction can provide an additional value field, which contains the value of the transaction. The sending party, such as the user, can send a transaction to the intermediate party. such as the platform, with the value field identified the value of the transaction. Thus, in the transaction, the value field is linked to the value that the sending party desires to send to the receiving party.

In the modified transaction, the value field can be unchanged, e.g., the platform is configured to send a same amount of value to the supplier. Alternatively, the platform can increase or decrease the value, based on an agreement with the supplier, for example.

Further, the modification of the transaction can provide an additional supplier field to contain information from the receiving party, such as instructions specifically related to the transaction. The intermediate party can contact the receiving party to inquire if there is any particular aspect of the transaction that the receiving party prefers. Alternatively, the receiving party can specify the instruction related to the transaction, which can be applied to all transactions involving the receiving party.

The additional supplier field can be added to the modified transaction, e.g., there is no supplier field in the original transaction. An advantage of the modified transaction is the customization of information in the transaction, such as the addition of the supplier field, which can let the intermediate party to tailor the transaction to suit individual receiving parties.

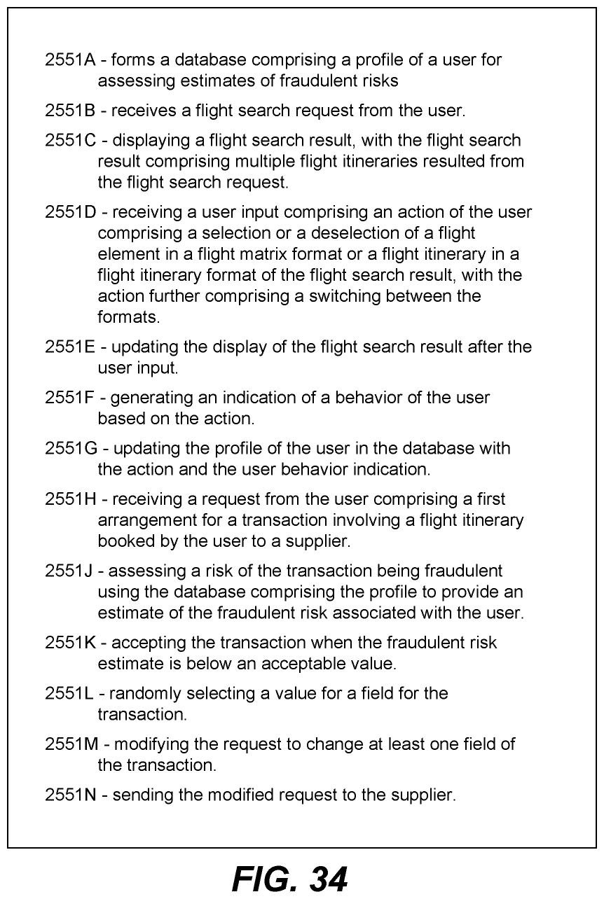

FIG. 34 illustrates a flow chart for processing a user transaction according to some embodiments. Operation 2551A forms a database comprising a profile of a user for assessing estimates of fraudulent risks.

Operation 2551B receives a flight search request from the user. Operation 2551C displays a flight search result, with the flight search result comprising multiple flight itineraries resulted from the flight search request. Operation 2551D receives a user input comprising an action of the user comprising a selection or a deselection of a flight element in a flight matrix format or a flight itinerary in a flight itinerary format of the flight search result, with the action further comprising a switching between the formats.

Operation 2551E updates the display of the flight search result after the user input. Operation 2551F generates an indication of a behavior of the user based on the action. Operation 2551G updates the profile of the user in the database with the action and the user behavior indication.

Operation 2551H receives a request from the user comprising a first arrangement for a transaction involving a flight itinerary booked by the user to a supplier. Operation 2551J assesses a risk of the transaction being fraudulent using the database comprising the profile to provide an estimate of the fraudulent risk associated with the user. Operation 2551K accepts the transaction when the fraudulent risk estimate is below an acceptable value.

Operation 2551L randomly selects a value for a field for the transaction. Operation 2551M modifies the request to change at least one field of the transaction. Operation 2551N sends the modified request to the supplier.

In some embodiments, the present invention discloses a computer-implemented method to provide a service or a product to users. The method can include authenticating a user based on a behavior profile, and changing a transaction sent by the user to a supplier providing the service or product. The authentication process can be based on a profile of the user, which can use an AI algorithm to compare a current action or a current communication session to a behavior pattern of the user generated based on the profile.

The method includes authenticating a transaction request from a user for a flight itinerary. As discussed above with respect to the authentication process using a behavior profile, the authentication includes (1) forming or updating, by a platform, a database comprising profiles of multiple users for assessing estimates of fraudulent risks, (2) receiving a flight search request from the user, (3) displaying a flight search result, with the flight search result comprising multiple flight itineraries resulted from the flight search request, (4) receiving a user input comprising a second action of the user comprising a selection or a deselection of a flight element in the flight matrix format or a flight itinerary in the flight itinerary format, (5) updating the display of the flight search result after the user input, with the selection of the flight element removing flight itineraries not meeting the selected flight element, and with the deselection of the flight element removing flight itineraries meeting the deselected flight element, (6) generating an indication of a behavior of the user based on at least the first and second actions, (7) updating the profile of the user in the database with the first and second actions and the user behavior indication, (8) receiving a request from the user comprising a first arrangement for a transaction involving a flight itinerary booked by the user to a supplier providing the booked flight itinerary, (9) assessing a risk of the transaction being fraudulent using the database comprising the profile to provide an estimate of the fraudulent risk associated with the user, and (10) accepting the transaction when the fraudulent risk estimate is below an acceptable value. Assessing a risk of the transaction being fraudulent comprises authenticating an identity of the user or assessing an ability of the user with regard to the transaction.

After receiving the transaction request from the user, the method further includes (11) randomly selecting a value for a field for the transaction; (12) modifying the transaction to change at least one field of the transaction, and (13) sending the modified transaction to the supplier.

The method can further include updating the profile with information about the transaction and the acceptance of the fraudulent risk of the user, e.g., the profile is updated with the information from the current transaction, and the acceptance that the fraudulent risk is low.

The transaction or the transaction request can include multiple data fields to identify the characteristics of the transaction. A first data field of the transaction or the transaction request can be a present field, which is configured to show the present party, e.g., the party who is the current owner, who currently has a handle on the transaction, or who is currently responsible or liable for the transaction. A transaction can be linkable to one party among multiple parties, with the present data field identifies the party who the transaction is currently linked to. In some cases, the transaction can be considered as a shared bus, which is shared between multiple modules, but there is one module at a time can have access to the bus.

In the original transaction, when the user sends the original transaction to the platform, the first data field, or the present field, can be linked to the user or can contain the username or identity, which is to signify that the user currently owns the transaction, or the user is currently responsible or liable for the transaction.

In the modified transaction, the first data field can be changed or modified to link to the platform, such as to contain a link to the platform or to contain the platform name or identity. The modification is configured to show that in the modification, when the platform sends the modified transaction to the supplier, the platform is now the current owner, and the platform now handle or otherwise responsible for the transaction. The change in the first data field in the modified transaction can free the user from after-transaction obligation, and can provide the platform with full authority when dealing with the supplier. In an analogy with a shared bus, the bus link to the user is terminated and the bus is now connected to the platform.

The transaction or the transaction request can include a second data field, which can be an originate field. The second data field is configured to show the party who originates the transaction, e.g., the origin party of the transaction. In the analogy with a shared bus, origin party is the party who starts the link to the bus. Then the bus link is severed with the origin party, and then passed to another party.

In the original transaction, when the user sends the original transaction to the platform, the second data field, or the originate field, can be linked to the user or can contain the username or identity, which is to signify that the user originates the transaction.

In the modified transaction, the second data field can be unchanged, e.g., is still linked to the user. The modification is configured to show that in the modification, when the platform sends the modified transaction to the supplier, the user is still the party who originates the transaction, even when the process of handling the transaction is now passed to the platform. The originate field linked to the user can let the supplier know that the user is the party who starts the transaction, with the platform being the responsible party, e.g., the current owner of the transaction, as shown by the present field.

The transaction or the transaction request can include a third data field, which can be a processing field. The third data field is configured to show the processing data of the transaction, such as the information to enable the supplier to process the transaction. For example, the processing data can include an account information, which can include a number for processing the transaction, and a type of processing transaction.

The processing data for the third data field can be randomly selected, for example, to simulate the variation of different transaction data coming from different users. Thus the platform can randomize the processing value for the modified transaction before sending to the supplier. The randomization of the processing data can be configured to avoid clustering the processing data field with subsequent or previous transactions for other users.

In the original transaction, when the user sends the original transaction to the platform, the third data field, or the processing field, can contain account information supplied by the user, for example, which is configured to compensate for the booked flight itinerary.

In the modified transaction, the third data field can be changed to a randomized account information from the platform, e.g., an account information randomly selected amount multiple account information of the platform. The modification is configured to provide compensation for the supplier by the platform, instead of by the user.

The transaction or the transaction request can include a fourth data field, which can be a value field. The fourth data field is configured to show the value of the transaction, such as the price of the service or product that the supplier offers.

In the original transaction, when the user sends the original transaction to the platform, the fourth data field, or the value field, can contain the value of the product or service offered by the supplier, for example, which is configured to compensate for the booked flight itinerary.

In the modified transaction, the fourth data field can be unchanged, e.g., the platform is configured to send a same amount of value to the supplier. Alternatively, the platform can change the fourth field, such as adding an extra value to reflect a compensation or a return value to the supplier, or subtracting an amount that reflects a service fee of the platform to the user, a promotion to the platform, or a discount from the supplier to the platform, such as for wholesale to the platform.

The transaction or the transaction request can include a fifth data field, which can be a supplier field. The fifth data field is configured to contain information provided by the supplier to the platform, such as instructions of how and where to direct the transaction. For example, the supplier information can include a destination of where the transaction is to be sent. The supplier information can include an account information, which can include a number and a type of the account for receiving the transaction.

The supplier field can enable a direct transfer for the transaction, e.g., bypassing the supplier to go directly from the platform to a destination chosen by the supplier, as specified in the supplier field. Further, the supplier field can contain instructions of how to send the transaction value, such as marking or labeling the transaction.

In the original transaction, there can be no supplier field, or the supplier field is blank. The supplier information can be provided only to the platform, for example, as a special transaction direction when the supplier establishes communication with the platform. Alternatively, the platform can inquire about the handling instruction of the transaction, such as to send the modified transaction directly to the supplier, or to a new destination.

Then, in the modified transaction, the platform can fill in the supplier direction in the supplier field, which then enables the transaction to be sent directly to the destination specified in the supplier field.

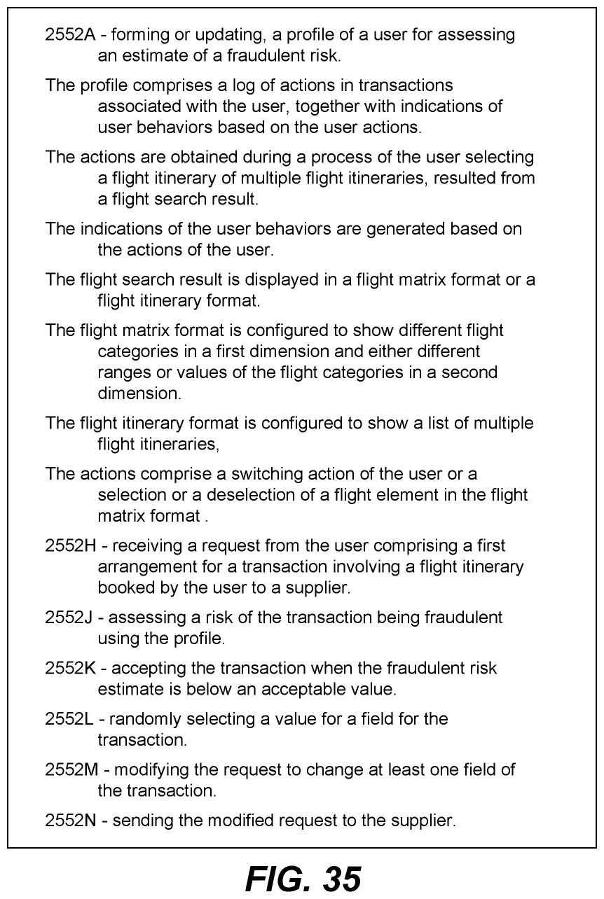

FIG. 35 illustrates a flow chart for processing a user transaction according to some embodiments. Operation 2552A forms or updates, a profile of a user for assessing an estimate of a fraudulent risk. The profile comprises a log of actions in transactions associated with the user, together with indications of user behaviors based on the user actions. The actions are obtained during a process of the user selecting a flight itinerary of multiple flight itineraries, resulted from a flight search result. The indications of the user behaviors are generated based on the actions of the user.

The flight search result is displayed in a flight matrix format or a flight itinerary format. The flight matrix format is configured to show different flight categories in a first dimension and either different ranges or values of the flight categories in a second dimension. The flight itinerary format is configured to show a list of multiple flight itineraries. The actions comprise a switching action of the user or a selection or a deselection of a flight element in the flight matrix format.

Operation 2552B receives a request from the user comprising a first arrangement for a transaction involving a flight itinerary booked by the user to a supplier. Operation 2552C assesses a risk of the transaction being fraudulent using the profile. Operation 2552D accepts the transaction when the fraudulent risk estimate is below an acceptable value.

Operation 2552E randomly selects a value for a field for the transaction. Operation 2552F modifies the request to change at least one field of the transaction. Operation 2552G sends the modified request to the supplier.

In some embodiments, the present invention discloses a computer-implemented method to form a profile for a user, which can be used to authenticate the user through an AI algorithm comparing a current action or a current communication session to a behavior pattern of the user generated based on the profile. The method includes (1) forming or updating, by a platform, a profile of a user for assessing an estimate of a fraudulent risk, (2) receiving a request from the user for a transaction involving a flight itinerary booked by the user to a supplier providing the booked flight itinerary, (3) assessing a risk of the transaction being fraudulent using the profile to provide an estimate of the fraudulent risk associated with the user, (4) accepting the transaction when the fraudulent risk estimate is below an acceptable value, and (5) sending the request to the supplier.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
forming or updating, by a platform, a database comprising profiles of multiple users for assessing estimates of fraudulent risks,
wherein a profile of the profiles comprises a log of actions in transactions associated with a user of the multiple users, together with indications of user behaviors based on the user actions;
receiving a flight search request from the user;
displaying a flight search result, with the flight search result comprising multiple flight itineraries resulted from the flight search request,
wherein the flight search result is displayed in a flight matrix format or a flight itinerary format,
wherein the flight matrix format is configured to show multiple flight elements configured in different flight categories in a first dimension and either different ranges or values of the flight categories in a second dimension,
wherein the flight itinerary format is configured to show a list of the multiple flight itineraries, and
wherein each of the flight matrix format and the flight itinerary format comprises a command selectable by a first action of the user for switching between the formats;
receiving a user input comprising a second action of the user comprising a selection or a deselection of a flight element in the flight matrix format or a flight itinerary in the flight itinerary format;
updating the display of the flight search result after the user input, with the selection of the flight element removing flight itineraries not meeting the selected flight element, and with the deselection of the flight element removing flight itineraries meeting the deselected flight element;
generating an indication of a behavior of the user based on at least the first and second actions;
updating the profile of the user in the database with the first and second actions and the user behavior indication;
receiving a request from the user for a transaction involving a flight itinerary booked by the user to a supplier providing the booked flight itinerary;
assessing a risk of the transaction being fraudulent using the database comprising the profile to provide an estimate of the fraudulent risk associated with the user,
wherein the estimate of the fraudulent risk is performed by an artificial intelligent algorithm characterizing the transaction request to be whether or not a deviation from a pattern of the user behavior based on the actions and the behavior indications of the user characterized by the profile, and
wherein a risk level higher than a threshold value causes the artificial intelligent algorithm to perform additional authentication steps;
accepting the transaction when the fraudulent risk estimate is below an acceptable value; and
sending the request to the supplier.

2. The method of claim 1, wherein at least one element of the flight matrix is configured to show that there is not a flight itinerary of the multiple flight itineraries meeting the flight category and the range or value of the at least one element.

3. The method of claim 1, wherein the profile further comprises information related to the user and collected by the platform, with the profile comprising at least one of a password, a PIN number, secret questions, or a numerical sequence, possession comprising at least one of a mobile phone, wearable devices, a token, or a smartcard, inherent feature comprising at least one of fingerprint, voice recognition, iris recognition, or facial features, data from agencies or institutions, data supplied by the user including data supplied to the platform by the user comprising email address or billing address, or data inferred from communication between the user and the platform, comprising at least one of location or communication equipment used by the user.

4. The method of claim 1, wherein:
the user behavior indications comprise transaction values, transaction volumes, transaction rates, transaction locations, transaction times, generated based on the first and second actions, Internet Protocol (IP) addresses, login times, login locations, mouse and keyboard usage, or devices used obtained from communication between the user and the platform, and
the user behavior indications are configured to provide the pattern of user behavior used in the artificial intelligent algorithm to determine the fraudulent risk.

5. The method of claim 1, further comprising:
updating, by the platform, the profile with information about the transaction and the acceptance of the fraudulent risk of the user.

6. The method of claim 1, wherein:
the second action comprises a selection or a deselection of one or more flight elements in the flight matrix format, and
the display of the flight search result is updated with the selection of the one or more flight elements removing flight itineraries not meeting the selected one or more flight elements, and with the deselection of the one or more flight elements removing flight itineraries meeting the selected one or more flight elements.

7. The method of claim 1, wherein:
the user behavior indications comprise a delay time between two consecutive user inputs, and
the user behavior indication is generated to provide the pattern of user behavior.

8. A computer-implemented method comprising:
forming or updating, by a platform, a database comprising profiles of multiple users for assessing estimates of fraudulent risks,
wherein a profile of the profiles comprises a log of actions in transactions associated with a user of the multiple users, together with indications of user behaviors based on the user actions;
receiving a flight search request from the user;
displaying a flight search result, with the flight search result comprising multiple flight itineraries resulted from the flight search request,
wherein the flight search result is displayed in a flight matrix format or a flight itinerary format,
wherein the flight matrix format is configured to show multiple flight elements configured in different flight categories in a first dimension and either different ranges or values of the flight categories in a second dimension,
wherein the flight itinerary format is configured to show a list of the multiple flight itineraries, and
wherein each of the flight matrix format and the flight itinerary format comprises a command selectable by a first action of the user for switching between the formats;
receiving a user input comprising a second action of the user comprising a selection or a deselection of a flight element in the flight matrix format or a flight itinerary in the flight itinerary format;
updating the display of the flight search result after the user input, with the selection of the flight element removing flight itineraries not meeting the selected flight element, and with the deselection of the flight element removing flight itineraries meeting the deselected flight element;
generating an indication of a behavior of the user based on at least the first and second actions;
receiving a request from the user for a transaction involving a flight itinerary booked by the user to a supplier providing the booked flight itinerary,
wherein the transaction comprises a first data field linked to the user, a second data field linked to the user, and a third data field comprising data of the transaction;
assessing a risk of the transaction being fraudulent using the database comprising the profile to provide an estimate of the fraudulent risk associated with the user,
wherein the estimate of the fraudulent risk is performed by an artificial intelligent algorithm characterizing the transaction request to be whether or not a deviation from a pattern of the user behavior based on the actions and the behavior indications of the user characterized by the profile;
accepting the transaction when the fraudulent risk estimate is below an acceptable value;
randomly selecting a processing value for the data field for the transaction;
modifying the transaction to change the first and third fields of the transaction,
wherein the first data field is changed to link to the platform,
wherein the third data field is changed to the processing value, and
wherein the second data field is remained unchanged, with the unchanged second data field configured to make the user an originated party; and
sending the modified transaction to the supplier.

9. The method of claim 8, wherein assessing a risk of the transaction being fraudulent comprises authenticating an identity of the user.

10. The method of claim 8, wherein assessing a risk of the transaction being fraudulent comprises assessing an ability of the user with regard to the transaction.

11. The method of claim 8, wherein the artificial intelligent algorithm is configured to perform additional authentication steps when a risk level is higher than a threshold value.

12. The method of claim 8, wherein:
the change of the first data field configured to make the platform a responsible party,
the change of the third data field configured to avoid clustering the data field with subsequent or previous transactions for other users, and
the unchanged second data field is configured to make the user an originated party.

13. The method of claim 8, wherein the transaction further comprises a fourth data field linked to a value of the transaction.

14. The method of claim 8, further comprising:
modifying the transaction to change the first and third fields of the transaction,
wherein the transaction further comprises a fifth data field, and
wherein the modifying comprises changing the fifth data field to comprise data received from the supplier.

15. A computer-implemented method comprising:
forming or updating, by a platform, a profile of a user for assessing an estimate of a fraudulent risk,
wherein the profile comprises a log of actions in transactions associated with the user, together with indications of user behaviors based on the user actions,
wherein the actions are obtained during a process of the user selecting a flight itinerary of multiple flight itineraries, with the multiple flight itineraries resulted from a flight search result presented to the user based on a flight search request from the user,
wherein the indications of the user behaviors are generated based on the actions of the user,
wherein the flight search result is displayed in a flight matrix format or a flight itinerary format,
wherein the flight matrix format is configured to show multiple flight elements configured in different flight categories in a first dimension and either different ranges or values of the flight categories in a second dimension,
wherein the flight itinerary format is configured to show a list of the multiple flight itineraries,
wherein the actions comprise a switching action of the user between the flight matrix format and the flight itinerary format using a command displayed together with the flight matrix format and the flight itinerary format,
wherein the actions comprise a selection or a deselection of a flight element in the flight matrix format or a flight itinerary in the flight itinerary format,
wherein after the selection action, the display of the flight search result is updated with flight itineraries not meeting the selected flight element removed from the flight matrix format, and
wherein after the deselection action, the display of the flight search result is updated with flight itineraries meeting the deselected flight element removed from the flight matrix format;
receiving a request from the user for a transaction involving a flight itinerary booked by the user to a supplier providing the booked flight itinerary,
wherein the transaction comprises a first data field linked to the user, a second data field linked to the user, and a third data field comprising data of the transaction;
assessing a risk of the transaction being fraudulent using the profile to provide an estimate of the fraudulent risk associated with the user,
wherein the estimate of the fraudulent risk is performed by an artificial intelligent algorithm characterizing the transaction request to be whether or not a deviation from a pattern of the user behavior based on the actions and the behavior indications of the user characterized by the profile, and
wherein a risk level higher than a threshold value causes the artificial intelligent algorithm to perform additional authentication steps;
accepting the transaction when the fraudulent risk estimate is below an acceptable value;
updating, by the platform, the profile with information about the transaction and the acceptance of the fraudulent risk of the user;
randomly selecting a processing value for the data field for the transaction;
modifying the transaction to change the first and third fields of the transaction,
wherein the first data field is changed to link to the platform, with the change of the first data field configured to make the platform a responsible party,
wherein the third data field is changed to the processing value, with the change of the third data field configured to avoid clustering the data field with subsequent or previous transactions for other users,
wherein the second data field is remained unchanged, with the unchanged second data field configured to make the user an originated party; and
sending a substituted request to the supplier.

16. The method of claim 15, wherein the profile further comprises information related to the user and collected by the platform, with the profile comprising at least one of a password, a PIN number, secret questions, or a numerical sequence, possession comprising at least one of a mobile phone, wearable devices, a token, or a smartcard, inherent feature comprising at least one of fingerprint, voice recognition, iris recognition, or facial features, data from agencies or institutions, data supplied by the user including data supplied to the platform by the user comprising email address or billing address, or data inferred from communication between the user and the platform, comprising at least one of location or communication equipment used by the user.

17. The method of claim 15, wherein:
the user behavior indications comprise transaction values, transaction volumes, transaction rates, transaction locations, transaction times, generated based on the first and second actions, Internet Protocol (IP) addresses, login times, login locations, mouse and keyboard usage, or devices used obtained from communication between the user and the platform, and
the user behavior indications are configured to provide the pattern of user behavior used in the artificial intelligent algorithm to determine the fraudulent risk.

18. The method of claim 15, wherein assessing a risk of the transaction being fraudulent comprises authenticating an identity of the user or assessing an ability of the user with regard to the transaction.

19. The method of claim 15, wherein the transaction further comprises a fourth data field linked to a value of the transaction.

20. The method of claim 15, further comprising:
modifying the transaction to change the first and third fields of the transaction,
wherein the transaction further comprises a fifth data field, and
wherein the modifying comprises changing the fifth data field to comprise data received from the supplier.
